(19) United States
(12) Patent Application Publication
(10) Pub. No.: US 2026/0093011 A1
(43) Pub. Date: Apr. 2, 2026

(54) RADAR APPARATUS

(71) Applicant: DENSO CORPORATION, Kariya-city (JP)

(72) Inventors: SATORU SHIMIZU, Kariya-city (JP); CHIHIRO ARAI, Kariya-city (JP); YUKOU MURASE, Kariya-city (JP); OSAMU ISAJI, Kariya-city (JP)

(21) Appl. No.: 19/400,780

(22) Filed: Nov. 25, 2025

Related U.S. Application Data
(63) Continuation of application No. PCT/JP2024/019553, filed on May 28, 2024.

(30) Foreign Application Priority Data
May 31, 2023 (JP) 2023-089682

(51) Int. Cl. G01S 7/40; G01S 7/35; G01S 13/58

(52) U.S. Cl. CPC G01S 7/406; G01S 7/354; G01S 7/356; G01S 7/4056; G01S 13/583

(57) ABSTRACT

A radar apparatus includes a plurality of transmission antennas, a plurality of reception antennas, a number Ns of transmission circuits connected to the transmission antennas and configured to output a transmission signal, a number Nr of reception circuits connected to the reception antennas and configured to acquire a reception signal, a clock generation unit configured to output a clock signal to each of the reception circuits, and a control unit configured to process the reception signals.

### CROSS REFERENCE TO RELATED APPLICATIONS

The present application is a continuation application of International Patent Application No. PCT/JP2024/019553 filed on May 28, 2024 which designated the U. S. and claims the benefit of priority from Japanese Patent Application No. 2023-089682 filed on May 31, 2023. The entire disclosures of all of the above applications are incorporated herein by reference.

### TECHNICAL FIELD

The present disclosure relates to radar technology.

### BACKGROUND

A related art discloses a radar system. This system includes a reception channel configured to generate a first digital intermediate frequency (IF) signal based on a reflected signal, in which the reflected signal is reflected from a reflector at a known position and angle. The system further includes a reference reception channel configured to generate a second digital IF signal based on the reflected signal. The system includes a digital mismatch compensation circuit element coupled to receive the first digital IF signal and the second digital IF signal, the digital mismatch compensation circuit element being configured to process the first digital IF signal and the second digital IF signal to compensate for mismatches between the reception channel and the reference reception channel.

### SUMMARY

According to an aspect of the present disclosure, a radar apparatus includes: a plurality of transmission antennas; a plurality of reception antennas; a number Ns of transmission circuits connected to the transmission antennas and configured to output a transmission signal; a number Nr of reception circuits connected to the reception antennas and configured to acquire a reception signal; a clock generation unit configured to output a clock signal to each of the reception circuits; and a control unit configured to process the reception signals. Ns and Nr are each integers of 2 or more. The plurality of transmission antennas and the plurality of reception antennas may be arranged such that: (i) at least one of the plurality of transmission antennas and the plurality of reception antennas are arranged is arranged at unequal intervals; (ii) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets; (iii) at least one different wiring length set is included, which is a set of virtual antennas with overlapping virtual positions and different wiring lengths; and (iv) a total number of belonging sets, which are sets of virtual antennas belonging to at least one of the unique sets and the different wiring length sets, is at least Ns+Nr−1 sets. The control unit may be configured to, for the detection signals of the same target in the reception signals between the virtual antennas in at least Ns+Nr−1 belonging sets, based on a comparison result for a plurality of targets at different distances, compensate for a phase difference corresponding to the wiring length difference between the virtual antennas, a phase difference between different transmission circuits, a phase difference between different reception circuits, and a phase difference due to delay of the clock signal.

### BRIEF DESCRIPTION OF DRAWINGS

Objects, features and advantages of the present disclosure will become more apparent from the following detailed description made with reference to the accompanying drawings. In the drawings:

FIG. 1 is a schematic diagram illustrating the basic configuration of the radar apparatus according to the first embodiment;

FIG. 2 is a schematic diagram illustrating an example of combinations of transmission circuits and transmission antennas, and reception circuits and reception antennas, according to the first embodiment;

FIG. 3 is a schematic diagram illustrating an example of the arrangement of transmission antennas and reception antennas according to the first embodiment;

FIG. 4 is a schematic diagram illustrating virtual antennas assumed in the first embodiment;

FIG. 5 is a block diagram illustrating the functional configuration of the control unit according to the first embodiment;

FIG. 6 is a flowchart illustrating the control flow according to the first embodiment;

FIG. 7 is a graph illustrating an example of the relationship between wiring length difference and phase error;

FIG. 8 is a graph illustrating an example of the relationship between parameters related to phase error and temperature;

FIG. 9 is a table illustrating an example of sets of virtual antennas used for compensation processing;

FIG. 10 is a graph illustrating the relationship between phase error between transmission circuits and temperature;

FIG. 11 is a graph illustrating the relationship between phase error between reception circuits and temperature;

FIG. 12 is a graph for explaining the delay of the clock signal;

FIG. 13 is a graph illustrating differences in beat frequency according to the distance to the target;

FIG. 14 is a schematic diagram illustrating an example of the arrangement of transmission antennas and reception antennas according to the second embodiment;

FIG. 15 is a schematic diagram illustrating virtual antennas assumed in the second embodiment;

FIG. 16 is a schematic diagram illustrating an example of the arrangement of transmission antennas and reception antennas according to the third embodiment;

FIG. 17 is a schematic diagram illustrating virtual antennas assumed in the third embodiment;

FIG. 18 is a table illustrating an example of sets of virtual antennas used for compensation processing;

FIG. 19 is a schematic diagram illustrating an example of combinations of transmission circuits and transmission antennas, and reception circuits and reception antennas, according to the fourth embodiment;

FIG. 20 is a schematic diagram illustrating an example of the arrangement of transmission antennas and reception antennas according to the fourth embodiment;

FIG. 21 is a schematic diagram illustrating virtual antennas assumed in the fourth embodiment;

FIG. 22 is a graph illustrating the relative relationship of wiring lengths between virtual antennas assumed in the fourth embodiment; and

FIG. 23 is a table illustrating an example of sets of virtual antennas used for compensation processing in the fifth embodiment.

### DETAILED DESCRIPTION

In the related art, the phase difference between the reception channel and the reference reception channel is affected not only by routing delay mismatch but also by the position of the target and the phase difference between circuits. In the system of the related art, it is not possible to compensate for the phase difference caused by these factors, which may result in reduced compensation accuracy.

The present disclosure provides a radar apparatus capable of improving compensation accuracy.

According to one aspect of the present disclosure, a radar apparatus comprises: a plurality of transmission antennas; a plurality of reception antennas; a number Ns of transmission circuits connected to the transmission antennas and configured to output a transmission signal; a number Nr of reception circuits connected to the reception antennas and configured to acquire a reception signal; a clock generation unit configured to output a clock signal to each of the reception circuits; and a control unit configured to process the reception signals. Ns and Nr are each integers of 2 or more. The plurality of transmission antennas and the plurality of reception antennas are arranged such that: (i) at least one of the plurality of transmission antennas and the plurality of reception antennas are arranged is arranged at unequal intervals; (ii) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets; (iii) at least one different wiring length set is included, which is a set of virtual antennas with overlapping virtual positions and different wiring lengths; and (iv) a total number of belonging sets, which are sets of virtual antennas belonging to at least one of the unique sets and the different wiring length sets, is at least Ns+Nr−1 sets. The control unit is configured to, for the detection signals of the same target in the reception signals between the virtual antennas in at least Ns+Nr−1 belonging sets, based on a comparison result for a plurality of targets at different distances, compensate for a phase difference corresponding to the wiring length difference between the virtual antennas, a phase difference between different transmission circuits, a phase difference between different reception circuits, and a phase difference due to delay of the clock signal.

According to one aspect of the present disclosure, a radar apparatus comprises: a plurality of transmission antennas arranged at equal intervals; a plurality of reception antennas arranged at equal intervals; a number Ns of transmission circuits connected to the transmission antennas and configured to output a transmission signal; a number Nr of reception circuits connected to the reception antennas and configured to acquire a reception signal; a clock generation unit configured to output a clock signal to each of the reception circuits; and a control unit configured to process the reception signals. Ns and Nr are each integers of 2 or more. The plurality of transmission antennas and the plurality of reception antennas are arranged such that: (i) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets; (ii) at least one different wiring length set is included, which is a set of virtual antennas with overlapping virtual positions and different wiring lengths; and (iii) a total number of belonging sets, which are sets of virtual antennas belonging to at least one of the unique sets and the different wiring length sets, is at least Ns+Nr−1 sets. The control unit is configured to, for the detection signals of the same target in the reception signals between the virtual antennas in at least Ns+Nr−1 belonging sets, based on a comparison result for a plurality of targets at different distances, compensate for a phase difference corresponding to the wiring length difference between the virtual antennas, a phase difference between different transmission circuits, a phase difference between different reception circuits, and a phase difference due to delay of the clock signal.

According to these embodiments, based on the comparison result of the reception signals between virtual antennas within at least (Ns+Nr−1) belonging sets, it is possible to compensate for the phase difference between different transmission circuits, the phase difference between different reception circuits, the phase difference corresponding to the wiring length difference between virtual antennas, and the phase difference due to the delay of the clock signal. Therefore, improvement in compensation accuracy can be achieved.

According to one aspect of the present disclosure, a radar apparatus comprises: a plurality of transmission antennas; a plurality of reception antennas; a number Ns of transmission circuits connected to the transmission antennas and configured to output a transmission signal; a number Nr of reception circuits connected to the reception antennas and configured to acquire a reception signal; a clock generation unit configured to output a clock signal to each of the reception circuits; and a control unit configured to process the reception signals. Ns and Nr are each integers of 2 or more. The plurality of transmission antennas and the plurality of reception antennas are arranged such that: (i) at least one of the plurality of transmission antennas and the plurality of reception antennas are arranged is arranged at unequal intervals; and (ii) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets. The control unit is configured to, for the detection signals of the same target in the reception signals between the virtual antennas in at least Ns+Nr−2 unique sets, based on a comparison result for a plurality of targets at different distances, compensate for a phase difference corresponding to the wiring length difference between the virtual antennas, a phase difference between different transmission circuits, a phase difference between different reception circuits, and a phase difference due to delay of the clock signal.

According to one aspect of the present disclosure, a radar apparatus comprises: a plurality of transmission antennas arranged at equal intervals; a plurality of reception antennas arranged at equal intervals; a number Ns of transmission circuits connected to the transmission antennas and configured to output a transmission signal; a number Nr of reception circuits connected to the reception antennas and configured to acquire a reception signal; a clock generation unit configured to output a clock signal to each of the reception circuits; and a control unit configured to process the reception signals. Ns and Nr are each integers of 2 or more. The plurality of transmission antennas and the plurality of reception antennas are arranged such that: among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets. The control unit is configured to, for the detection signals of the same target in the reception signals between the virtual antennas in at least Ns+Nr−2 unique sets, based on a comparison result for a plurality of targets at different distances, compensate for a phase difference corresponding to the wiring length difference between the virtual antennas, a phase difference between different transmission circuits, a phase difference between different reception circuits, and a phase difference due to delay of the clock signal.

According to these embodiments, based on the comparison result of the reception signals between virtual antennas within at least (Ns+Nr−2) unique sets, it is possible to compensate for the phase difference between different transmission circuits, the phase difference between different reception circuits, and the phase difference due to the delay of the clock signal. Therefore, improvement in compensation accuracy can be achieved.

Hereinafter, multiple embodiments of the present disclosure will be described with reference to the drawings. In each embodiment, corresponding components are denoted by the same reference numerals, and redundant descriptions may be omitted. Further, when only a part of a configuration is described in each embodiment, other parts of the configuration may be applied from previously described embodiments. Furthermore, not only the combinations of configurations explicitly described in each embodiment, but also, unless there is a particular hindrance to the combination, configurations of multiple embodiments may be partially combined even if not explicitly described.

### First Embodiment

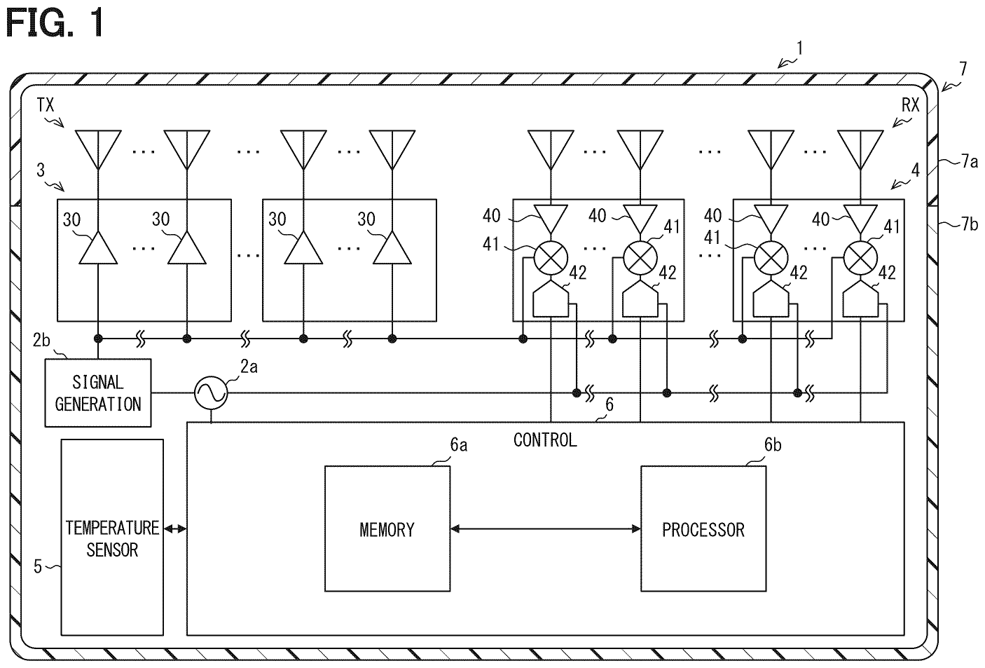

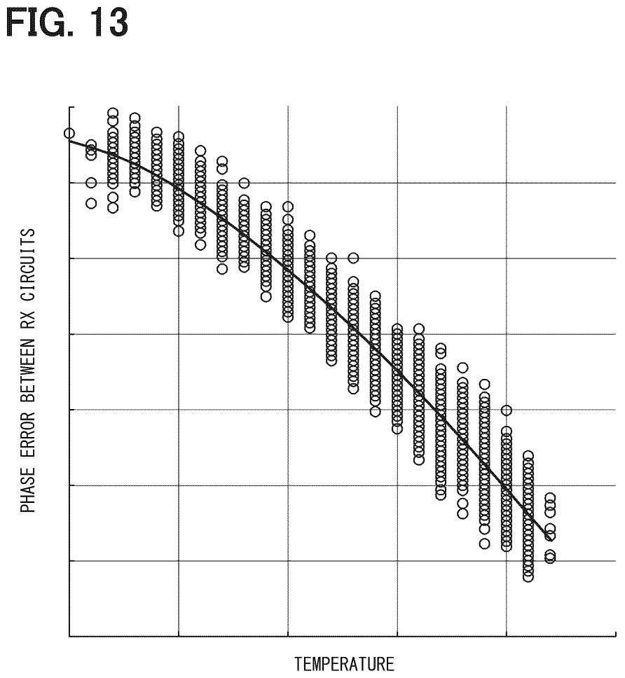

The first embodiment of the present disclosure will be described with reference to FIG. 1 to FIG. 13. The radar apparatus 1 is mounted, for example, on a mobile body such as a vehicle. The radar apparatus 1 transmits a transmission signal, receives the transmission signal reflected by an object as a reception signal, and detects, as target information, the distance to the target, which is the object that reflected the transmission signal, the relative speed with respect to the target, and the direction of the target.

The target information output from the radar apparatus 1 is input, for example, to an in-vehicle ECU (Electronic Control Unit) via an in-vehicle network such as CAN (Control Area Network, registered trademark) or Ethernet (registered trademark). The in-vehicle ECU executes various processes for autonomous driving and advanced driver assistance based on the target information acquired for each target.

Examples of processing based on the target information include collision avoidance processing and warning processing. Collision avoidance processing is a process for controlling the vehicle to avoid collision with the target by controlling the brake system, steering system, etc., based on the target information for each target. Warning processing is a process for warning the driver of the possibility of collision with the target based on the target information for each target.

As shown in the basic configuration of FIG. 1, the radar apparatus 1 of this embodiment includes a clock oscillator 2a, a signal generation unit 2b, a plurality of transmission circuits 3, a plurality of transmission antennas TX, a plurality of reception antennas RX, a plurality of reception circuits 4, a temperature sensor 5, a control unit 6, and a housing unit 7. The radar apparatus 1 is a so-called MIMO (Multiple-Input-Multiple-Output) radar, which virtually increases (pseudo-increases) the number of reception antennas RX beyond the actual number by transmitting transmission signals from a plurality of transmission antennas TX.

The clock oscillator 2a generates a periodic clock signal. The clock oscillator 2a transmits the clock signal to the signal generation unit 2b and each reception circuit 4. The clock oscillator 2a is an example of a “clock generation unit.” The signal generation unit 2b generates a modulated signal modulated at a modulation cycle corresponding to the clock signal. The modulated signal is, for example, a so-called chirp signal whose frequency changes over time. The modulated signal is distributed and output to each channel of the transmission circuits 3 and the reception circuits 4. Hereinafter, the modulated signal output from the signal generation unit 2b to the transmission circuits 3 is referred to as the transmission signal. The modulated signal output from the signal generation unit 2b to the reception circuits 4 is referred to as the local signal.

The transmission circuits 3 and reception circuits 4 are mainly composed of semiconductor integrated circuit devices such as MMICs (Monolithic Microwave Integrated Circuits). The transmission circuit 3 is connected to the transmission antenna TX and outputs the transmission signal to the transmission antenna TX. If the number of transmission circuits 3 mounted in one radar apparatus 1 is Ns, Ns is an integer of 2 or more. The transmission circuit 3 is provided with the same number of amplifiers 30 as the connected transmission antennas TX. Each amplifier 30 amplifies the transmission signal output from the signal generation unit 2b and outputs it to the corresponding transmission antenna TX.

The transmission antenna TX converts the electrical signal supplied as the transmission signal from the signal generation unit 2b into a radio wave signal and transmits it to the outside (external environment). The transmission antenna TX is configured to include at least one antenna element. For example, the transmission antenna TX is a patch antenna provided with a plurality of antenna elements in a planar shape. The antenna element is disposed on the surface opposite to the ground plate of the dielectric substrate, with the ground plate provided on one side. The plurality of antenna elements are connected in series, for example, by a feed line that supplies the electrical signal.

The reception antenna RX receives, as a reception signal, a radio wave signal including the transmission signal reflected by a target serving as a reflector in the external environment. The reception antenna RX is connected to the corresponding reception circuit 4. The arrangement of the transmission antenna TX and the reception antenna RX will be described later.

The reception antenna RX converts the reception signal, which is a radio wave signal, into an electrical signal and outputs it to the corresponding reception circuit 4. Similar to the transmission antenna TX, the reception antenna RX is, for example, a patch antenna in which at least one antenna element is connected in series by a feed line.

The reception circuit 4 is connected to the reception antenna RX and acquires the reception signal received by the reception antenna RX. If the number of reception circuits 4 mounted in one radar apparatus 1 is Nr, Nr is an integer of 2 or more. The reception circuit 4 is provided with the same number of amplifiers 40, signal mixing units 41, and AD converters 42 as the connected reception antennas RX.

The amplifier 40 amplifies the reception signal received by the reception antenna and outputs it to the signal mixing unit 41. The signal mixing unit 41 generates a beat signal by mixing the local signal from the signal generation unit 2b and the reception signal. The generated beat signal is an interference signal representing the frequency difference between the reception signal and the local signal. The beat signal is output to the AD converter 42 after high-frequency components deviating from the frequency difference between the reception signal and the local signal are filtered by a low-pass filter (not shown).

The AD converter 42 converts the beat signal, which is a filtered analog signal, into a digital signal. The AD converter 42 acquires the clock signal output from the clock oscillator 2a, samples the beat signal at time intervals corresponding to the period of the clock signal, and digitizes it. The AD converter 42 sequentially outputs the digitized beat signal to the control unit 6.

The temperature sensor 5 detects the temperature inside the radar apparatus 1. The temperature sensor 5, for example, includes a thermistor and outputs temperature information corresponding to the resistance value of the thermistor. The temperature sensor 5 detects the temperature information of each transmission circuit 3 and reception circuit 4 and outputs it to the control unit 6.

The housing unit 7 is a housing that accommodates the transmission antenna TX, reception antenna RX, clock oscillator 2a, signal generation unit 2b, transmission circuit 3, reception circuit 4, temperature sensor 5, and control unit 6. The housing unit 7 includes a radome 7a and a case body 7b. The radome 7a is mainly formed of a transmissive material that allows millimeter-wave radio waves to pass through. The radome 7a is attached to the case body 7b so as to cover the antennas TX and RX. The radome 7a protects the antennas TX and RX and enables transmission and reception of signals by the antennas TX and RX through the transmission of radio waves. The case body 7b, together with the radome 7a, forms a housing space that accommodates the above-described components of the radar apparatus 1.

The control unit 6 is a control unit including at least one dedicated computer. The dedicated computer constituting the control unit 6 may be, for example, an ECU (Electronic Control Unit) specialized for controlling the radar apparatus 1.

The dedicated computer constituting the control unit 6 includes at least one memory 6a and at least one processor 6b. The memory 6a is a non-transitory tangible storage medium, such as a semiconductor memory, magnetic medium, or optical medium, that non-transitorily stores programs and data readable by the computer. Here, storage may refer to accumulation in which data is retained even when the sensor system is powered off, or temporary storage in which data is erased when the sensor system is powered off. The processor 6b may include at least one core selected from, for example, a CPU (Central Processing Unit), GPU (Graphics Processing Unit), RISC-CPU (Reduced Instruction Set Computer), DFP (Data Flow Processor), and GSP (Graph Streaming Processor). Alternatively, the processor 6b may be at least one of a digital circuit or an analog circuit. Here, the digital circuit may be at least one selected from, for example, ASIC (Application Specific Integrated Circuit), FPGA (Field Programmable Gate Array), SoC (System on a Chip), PGA (Programmable Gate Array), and CPLD (Complex Programmable Logic Device). Such digital circuits may also include the memory 6a storing programs.

The control unit 6 executes angle measurement processing to calculate the angle of a reflector relative to the radar apparatus 1 by processing multiple beat signals output from the plurality of reception circuits 4. The radar apparatus 1 ensures relatively high angular resolution by pseudo-increasing the number of reception antennas RX beyond the actual number using the MIMO method. In addition, the control unit 6 ensures relatively high angle measurement accuracy by executing compensation processing to compensate for phase differences and amplitude differences of signals occurring between different transmission circuits 3 and between different reception circuits 4.

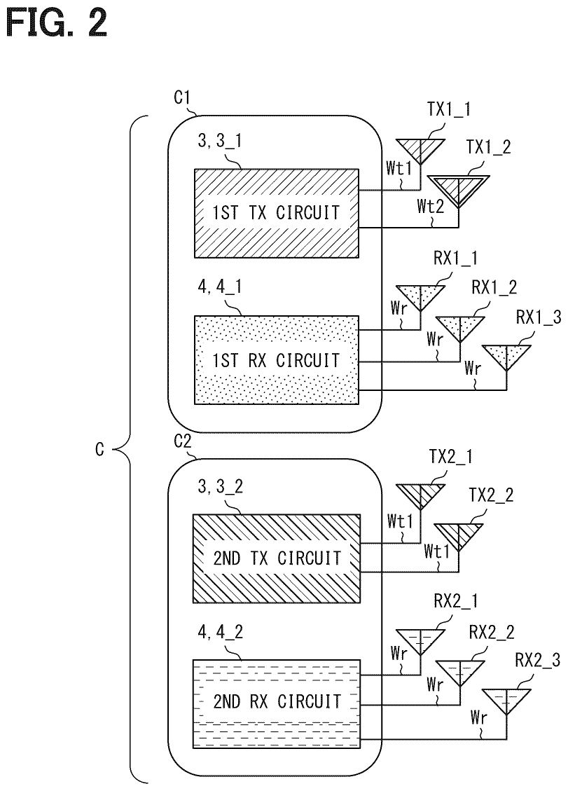

For the above-mentioned compensation processing, each transmission antenna TX and reception antenna RX are implemented in a prescribed arrangement. The arrangement of the transmission antennas TX and reception antennas RX will be described below with reference to specific examples shown in FIG. 2 to FIG. 4.

By means of the plurality of transmission antennas TX and the plurality of reception antennas RX, for each transmission antenna TX, a plurality of virtual antennas V are assumed for the plurality of reception antennas RX, corresponding to the phase difference of reception signals between the reception antennas RX. The virtual position of each virtual antenna V is defined by the relative position of the corresponding transmission antenna TX with respect to other transmission antennas TX, and the relative position of the corresponding reception antenna RX with respect to other reception antennas RX.

The transmission antennas TX and reception antennas RX are arranged such that, in the group of virtual antennas V assumed for each transmission antenna TX, within the collection of sets of virtual antennas where the virtual positions overlap and the combination of transmission circuit 3 and reception circuit 4 does not match, the number of unique sets, which is the sets of virtual antennas V in which the combination of transmission circuit 3 and reception circuit 4 does not overlap with other sets, is at least Ns+Nr−2 sets.

As an example, consider a radar apparatus 1 equipped with four transmission antennas TX and six reception antennas RX. In this example, the number of transmission circuits 3 is Ns=2, and the number of reception circuits 4 is Nr=2. In this case, as shown in FIG. 2, the number of channels in one transmission circuit 3 is at least two, and the number of channels in one reception circuit 4 is at least three. Hereinafter, one transmission circuit 3 is referred to as the first transmission circuit 3_1, and the other as the second transmission circuit 3_2. Similarly, one reception circuit 4 is referred to as the first reception circuit 4_1, and the other as the second reception circuit 4_2. In this embodiment, each circuit is implemented on a plurality of circuit chips C. Specifically, the first transmission circuit 3_1 and the first reception circuit 4_1 are implemented on the same first circuit chip C1, and the second transmission circuit 3_2 and the second reception circuit 4_2 are implemented on the same second circuit chip C2.

Furthermore, in the radar apparatus 1 of this embodiment, at least one transmission antenna TX has a wiring length different from that of the other transmission antennas TX. In the example shown in FIG. 2, the wiring Wt2 of the transmission antenna TX1_2 connected to the first transmission circuit 3_1 is longer than the wiring Wt1 of the other transmission antennas TX. The wiring length of each wiring Wr of the reception antennas RX is substantially the same. Furthermore, the transmission antennas TX and reception antennas RX are arranged such that the wiring length difference between virtual antennas in a belonging set described later reaches the allowable difference range.

Hereinafter, the four transmission antennas TX and six reception antennas RX may be distinguished by assigning different reference numerals to each. Specifically, the two transmission antennas TX connected to the first transmission circuit 3_1 are referred to as transmission antennas TX1_1 and TX1_2, and the two transmission antennas TX connected to the second transmission circuit 3_2 are referred to as transmission antennas TX2_1 and TX2_2. The three reception antennas RX connected to the first reception circuit 4_1 are referred to as reception antennas RX1_1, RX1_2, and RX1_3, and the three reception antennas RX connected to the second reception circuit 4_2 are referred to as reception antennas RX2_1, RX2_2, and RX2_3.

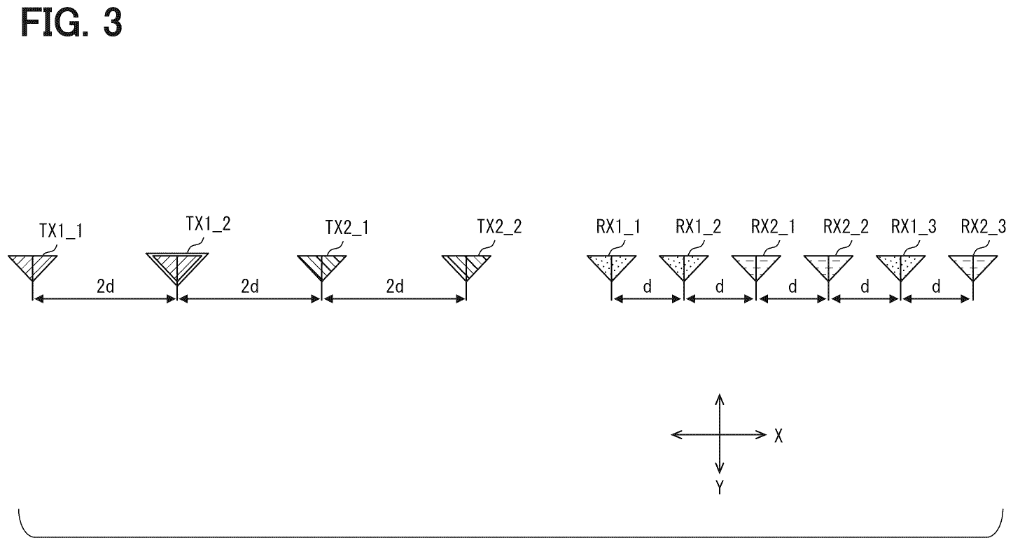

In the example shown in FIG. 3, the transmission antennas TX1_1, TX1_2, TX2_1, and TX2_2 are arranged at intervals of 2d along the X direction, which serves as the reference direction, from one side to the other in this order. Furthermore, the reception antennas RX1_1, RX1_2, RX2_1, RX2_2, RX2_3, and RX1_3 are arranged at intervals of d along the X direction, from one side to the other in this order.

When antennas with different wiring lengths exist, the transmission antennas TX and reception antennas RX are arranged such that, among the collection of sets of virtual antennas whose virtual positions overlap between groups of virtual antennas assumed for each transmission antenna TX and whose combinations of transmission circuits 3 and reception circuits 4 do not match, the number of unique sets of virtual antennas V, in which the combination of transmission circuit 3 and reception circuit 4 does not overlap with other sets, is at least Ns+Nr−2 sets, that is, two sets. In this embodiment, the transmission antennas TX and reception antennas RX are each arranged at equal intervals in a one-dimensional manner. Here, “one-dimensional arrangement” means that the antennas are arranged along a single reference direction.

For each transmission antenna TX1_1, TX1_2, TX2_1, and TX2_2, six virtual antennas V are assumed, corresponding to the number of reception antennas RX. That is, a total of 24 virtual antennas V are assumed.

Here, the multiple virtual antennas V assumed for transmission antenna TX1_1, from one side to the other, are referred to as virtual antennas V1, V2, V3, V4, V5, and V6. The multiple virtual antennas V assumed for transmission antenna TX1_2, from one side to the other, are referred to as virtual antennas V7, V8, V9, V10, V11, and V12. Furthermore, the group of virtual antennas V assumed for transmission antenna TX2_1, from one side to the other, are referred to as virtual antennas V13, V14, V15, V16, V17, and V18. The group of virtual antennas V assumed for transmission antenna TX2_2, from one side to the other, are referred to as virtual antennas V19, V20, V21, V22, V23, and V24.

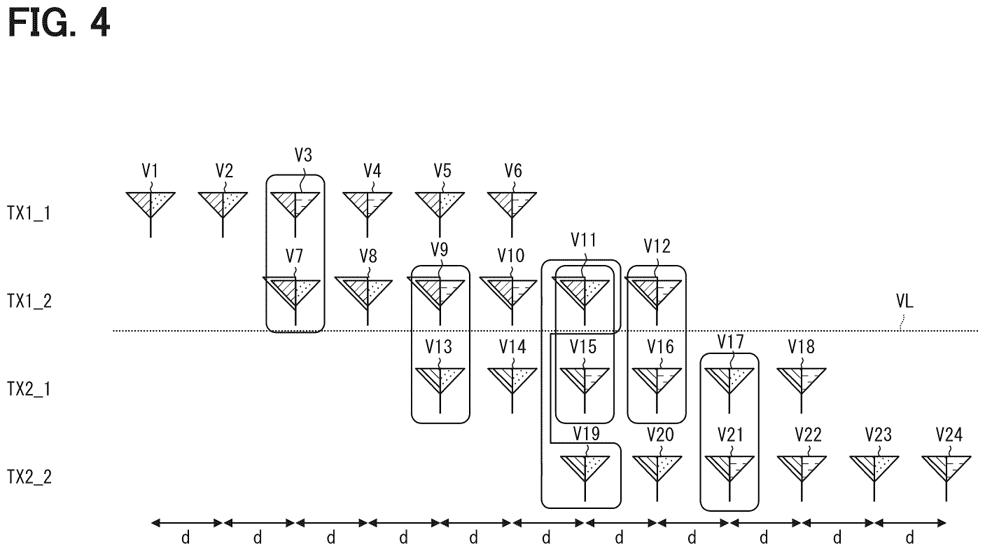

Since adjacent transmission antennas TX are arranged at intervals of 2d, the multiple virtual antennas V assumed for a particular transmission antenna TX are relatively shifted by 2d in virtual position compared to the multiple virtual antennas V assumed for an adjacent transmission antenna TX. Since the reception antennas RX are arranged at intervals of d, as shown in FIG. 4, there are 16 sets of virtual antennas V whose virtual positions overlap. In FIG. 4, for clarity, the virtual positions of the multiple virtual antennas V for each transmission antenna TX are depicted offset in the vertical direction of the page. Therefore, in reality, the multiple virtual antennas V are assumed to be located on a virtual line VL extending in the reference direction (X direction), with each virtual position defined accordingly. That is, in FIG. 4, virtual antennas V with the same horizontal position on the page constitute a set of virtual antennas V with overlapping virtual positions. Hereinafter, specific sets of virtual antennas V with overlapping virtual positions are denoted as (Vn, Vm) using the reference numerals assigned to each individual virtual antenna V (where n and m are natural numbers).

Specifically, the following pairs constitute sets of virtual antennas V with overlapping virtual positions: (V3, V7), (V4, V8), (V5, V9), (V5, V13), (V6, V10), (V6, V14), (V9, V13), (V10, V14), (V11, V15), (V11, V19), (V12, V16), (V12, V20), (V15, V16), (V16, V20), (V17, V21), and (V18, V22).

Among the above sets, the group of virtual antennas V in which the combination of transmission circuit 3 and reception circuit 4 does not match between the virtual antennas V includes 14 sets, excluding (V6, V10) and (V18, V22). Among this group of virtual antennas V, the number of sets in which the combination of transmission circuit 3 and reception circuit 4 does not overlap with other sets is six, thus satisfying the condition of at least Ns+Nr−2 sets. Examples of these six sets include (V3, V7), (V9, V13), (V11, V15), (V11, V19), (V12, V16), and (V17, V21).

Furthermore, the transmission antennas TX and reception antennas RX are arranged such that at least one set of different wiring length sets, which are sets of virtual antennas V with overlapping virtual positions and different wiring lengths, is included. The transmission antennas TX and reception antennas RX are arranged such that the total number of belonging sets, which are sets of virtual antennas V belonging to at least one of the above-mentioned unique sets and different wiring length sets, is at least Ns+Nr−1 sets.

Among the aforementioned example of six sets, different wiring length sets are included. Specifically, of these six sets, five sets except for (V17, V21) are different wiring length sets, thus satisfying the condition of at least one set. Accordingly, the total number of belonging sets is six, satisfying the condition of at least Ns+Nr−1 sets.

It should be noted that, as long as the combination of transmission circuit 3 and reception circuit 4 does not overlap with other sets, sets of virtual antennas V assumed for compensation processing may be other than those described above. For example, (V4, V8) and (V5, V9) overlap in the combination of transmission circuit 3 and reception circuit 4 with (V3, V7), but do not overlap with other sets. Therefore, assuming (V4, V8) or (V5, V9) as one of the six sets is equivalent to assuming (V3, V7).

Furthermore, if the control unit 6 secures at least Ns+Nr−2 sets of virtual antennas V whose combination of transmission circuit 3 and reception circuit 4 does not overlap with other sets, it may additionally assume sets that overlap in the combination of transmission circuit 3 and reception circuit 4 with those sets as sets to be used for compensation processing.

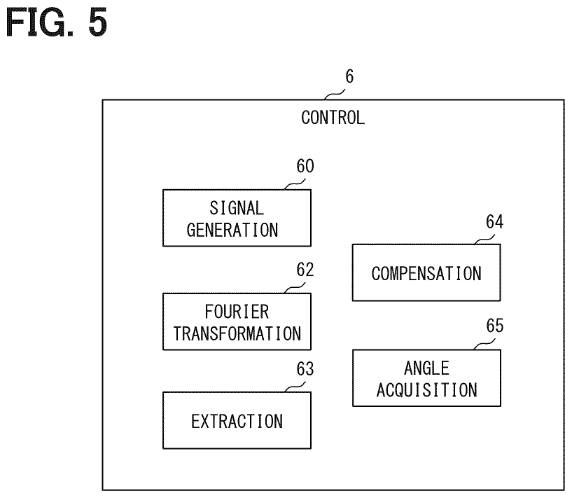

For the control of the radar apparatus 1 including the above compensation processing, the processor 6b executes multiple instructions included in the control program stored in the memory 6a. As a result, the control unit 6 constructs functional units for controlling the radar apparatus 1. Specifically, as shown in FIG. 5, the control unit 6 constructs, as functional units, a signal generation unit 60, a Fourier transform unit 62, an extraction unit 63, a compensation unit 64, and an angle acquisition unit 65.

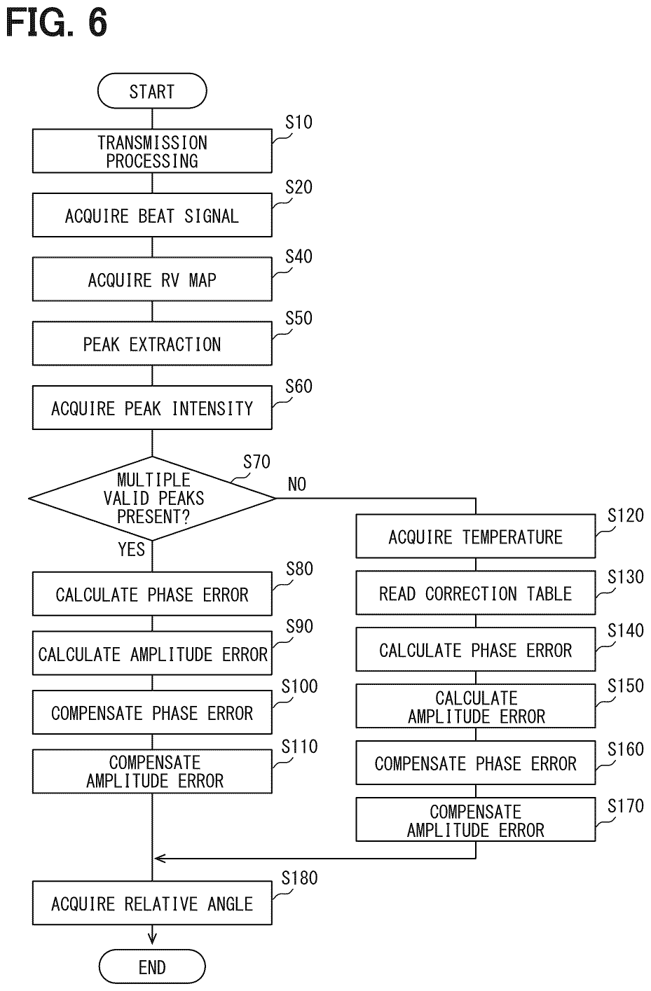

By means of these functions of the processor 6b, the radar control method by which the control unit 6 controls the radar apparatus 1 is executed according to the control flow shown in FIG. 6 to FIG. 8. This control flow is repeatedly executed while the vehicle is in operation. In this control flow, each “S” denotes a plurality of steps executed by multiple instructions included in the control program.

First, in S10 of FIG. 6, the signal generation unit 60 causes the signal generation unit 2b to output a transmission signal. In the subsequent S20, the Fourier transform unit 62 acquires, from the reception circuit 4, a beat signal corresponding to the reception signal received by the reception antenna RX after the transmission signal transmitted from the transmission antenna TX is reflected by the target. In the subsequent S40, the Fourier transform unit 62 executes FFT (Fast Fourier Transform) processing for each chirp of the AD-converted beat signal. As a result, the Fourier transform unit 62 acquires, for each chirp, a frequency spectrum (distance spectrum) exhibiting a peak at the frequency position corresponding to the distance to the target. The distance spectrum is data indicating the signal intensity for each distance bin according to the distance resolution.

The Fourier transform unit 62 then executes FFT processing on the distance spectrum. That is, the Fourier transform unit 62 performs a second FFT processing on the waveform obtained by arranging the phase at each distance bin from the first FFT processing for multiple chirps in time series. As a result, a frequency spectrum (velocity spectrum) exhibiting a peak at the position corresponding to the relative velocity with the target is obtained for each velocity bin. Through this two-dimensional FFT, the Fourier transform unit 62 acquires two-dimensional information (RV map) exhibiting a peak at the position corresponding to the distance to the target and the relative velocity of the target.

Next, in S50, the extraction unit 63 extracts the peak from the RV map as a detection signal. In the subsequent S60, the extraction unit 63 acquires the intensity of the extracted peak. Then, in S70, the extraction unit 63 determines whether there are multiple extracted peaks and whether they are valid. For example, the extraction unit 63 determines that a peak is valid if its intensity is within the allowable intensity range. Here, the allowable intensity range is a range in which the intensity is equal to or greater than a predetermined threshold. If it is determined that multiple valid peaks exist, the flow proceeds to S80.

In S80, the compensation unit 64 acquires the phase error between transmission circuits 3, between reception circuits 4, and corresponding to the wiring length difference of the virtual antennas V, based on the phase of valid peaks in each virtual channel. Here, the wiring length of a virtual antenna V refers to the total wiring length from the corresponding transmission antenna TX to the transmission circuit 3 and from the corresponding reception antenna RX to the reception circuit 4. In this case, only wiring Wt2 is longer than wiring Wt1, and all wirings Wr of the reception antennas RX are substantially equal in length, so the wiring length of the virtual antennas V assumed for transmission antenna TX1_2 is longer than that of the virtual antennas V assumed for other transmission antennas TX.

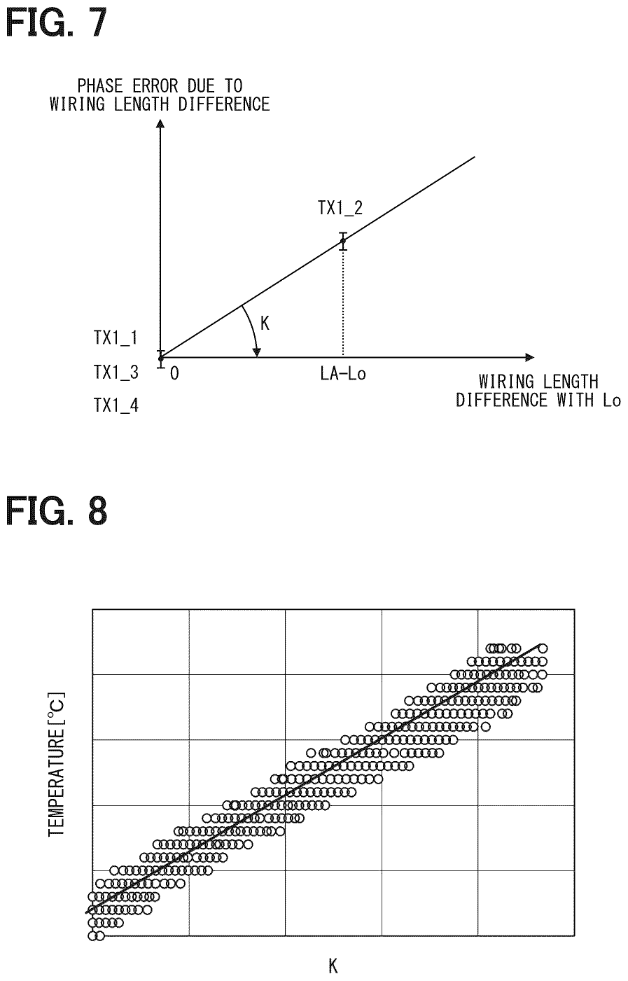

Generally, the phase error due to the wiring length difference for each virtual antenna V increases linearly according to the wiring length difference with respect to the reference wiring length Lo (for example, the shortest wiring length), as shown in FIG. 7. That is, the phase error with respect to the wiring length difference is a value obtained by multiplying the wiring length difference by parameter K. Therefore, as shown in FIG. 7, parameter K corresponds to the slope of the graph when the phase error with respect to the wiring length difference is plotted. That is, if the wiring length of the virtual antenna V assumed for transmission antenna TX1_2 is LA, parameter K can be calculated from the wiring length difference LA-Lo. In this case, the reference wiring length Lo is the wiring length at room temperature of the virtual antennas V assumed for transmission antennas TX other than TX1_2.

Parameter K is a parameter corresponding to the value obtained by multiplying the linear expansion coefficient of the wiring by the temperature of the wiring. Since the linear expansion coefficient of an object does not depend on temperature, parameter K is a temperature parameter that varies according to temperature. As shown in FIG. 8, parameter K increases linearly as the temperature increases.

In the phase compensation processing, the compensation unit 64 defines a linear equation for each of at least Ns+Nr−1 belonging sets of virtual antennas V, based on the phase difference of the peaks in the beat signals. In this linear equation, the relative phase error between transmission circuits 3, the relative phase error between reception circuits 4, and the relative phase error corresponding to the wiring length difference are defined as unknowns. The compensation unit 64 obtains the solution to this linear equation as the relative phase error. Since the beat signal is a signal related to the reception signal, the phase difference of the peaks in the beat signal is an example of the comparison result of the reception signals between virtual antennas V.

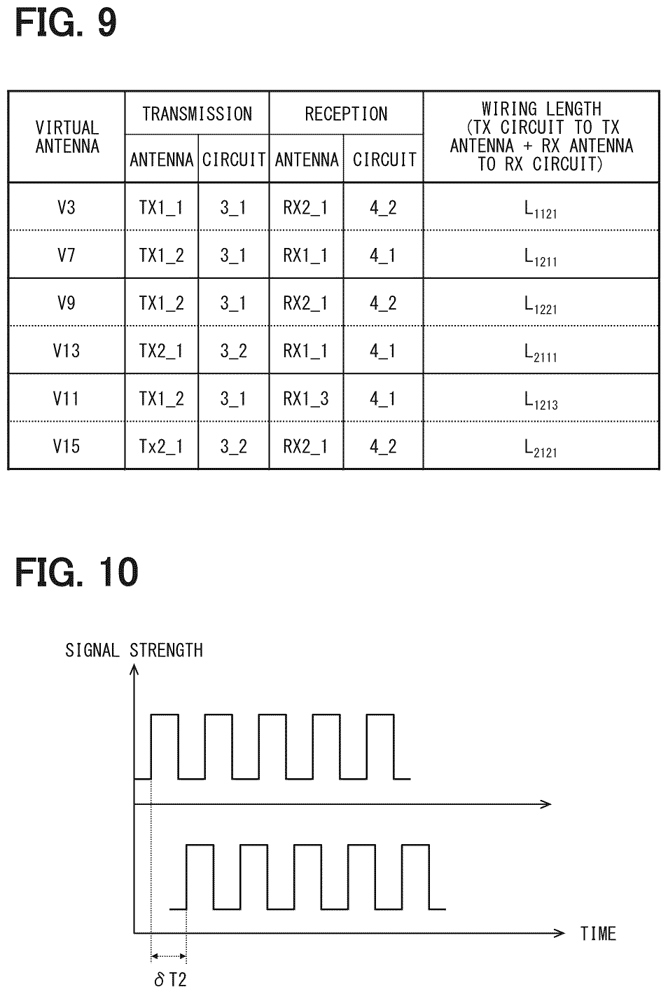

The acquisition of the relative phase error will be described in detail below. In the following description, the phase at the peak of the beat signal corresponding to virtual antenna Vn is denoted as θ_{Vn} (where n is a natural number). The wiring length difference in the virtual antenna V assumed for the combination of transmission antenna TXa_b and reception antenna RXc_d is denoted as L_{abij} (where a, b, i, and j are natural numbers). For simplicity, in the following description, the three sets (V3, V7), (V9, V13), and (V11, V15) shown in FIG. 9 are used as the belonging sets.

Furthermore, in the example described below, the phases at the peaks for two targets at different distances are compared. For each peak at a different distance, the frequency (beat frequency) of the corresponding beat signal is denoted as fa and fb. In this embodiment, the beat frequency for the target closer to the radar apparatus 1 (near target) is fa, and the beat frequency for the farther target (far target) is fb.

Here, the phase difference of the same peak for each virtual antenna V in each set is determined by the phase difference caused by the target, the phase error between transmission circuits 3, the phase error between reception circuits 4, and the phase error caused by the wiring length difference of the virtual antennas V. In addition, the phase difference of the same peak is also determined by the phase error (hereinafter, clock phase error) due to the delay (routing delay) corresponding to the time difference for the clock signal to reach each reception circuit 4 from the clock oscillator 2a.

Accordingly, the phase difference of the peak for the near target in (V3, V7), θ_{V3fa}-θ_{V7fa}, is defined by Equation (1); the phase difference of the peak for the near target in (V9, V13), θ_{V9fa}-θ_{V13fa}, is defined by Equation (2); and the phase difference of the peak for the near target in (V11, V15), θ_{V11fa}-θ_{V15fa}, is defined by Equation (3). In addition, the phase difference of the peak for the far target in (V3, V7), θ_{V3fb}-θ_{V7fb}, is defined by Equation (4); the phase difference of the peak for the far target in (V9, V13), θ_{V9fb}-θ_{V13fb}, is defined by Equation (5); and the phase difference of the peak for the far target in (V11, V15), θ_{V11fb}-θ_{V15fb}, is defined by Equation (6).

$${θ}_{V 3 fa} - {θ}_{V 7 fa} = ( {Θ}_{a} + {e}_{tx 1} + {e}_{rx 2} + {e}_{1121} + {β}_{2 a} ) - ( {Θ}_{a} + {e}_{tx 1} + {e}_{rx 1} + {e}_{1211} + {β}_{1 a} ) \qquad ( Equation 1 )$$

$${θ}_{V 9 fa} - {θ}_{V 13 fa} = ( {Θ}_{b} + {e}_{tx 1} + {e}_{rx 2} + {e}_{1221} + {β}_{2 a} ) - ( {Θ}_{b} + {e}_{tx 2} + {e}_{rx 1} + {e}_{2111} + {β}_{1 a} ) \qquad ( Equation 2 )$$

$${θ}_{V 11 fa} - {θ}_{V 15 fa} = ( {Θ}_{c} + {e}_{tx 1} + {e}_{rx 1} + {e}_{1213} + {β}_{1 a} ) - ( {Θ}_{c} + {e}_{tx 2} + {e}_{rx 2} + {e}_{2121} + {β}_{2 a} ) \qquad ( Equation 3 )$$

$${θ}_{V 3 fb} - {θ}_{V 7 fb} = ( {Θ}_{a} + {e}_{tx 1} + {e}_{rx 2} + {e}_{1121} + {β}_{2 a} ) - ( {Θ}_{a} + {e}_{tx 1} + {e}_{rx 1} + {e}_{1211} + {β}_{1 a} ) \qquad ( Equation 4 )$$

$${θ}_{V 9 fb} - {θ}_{V 13 fb} = ( {Θ}_{b} + {e}_{tx 1} + {e}_{rx 2} + {e}_{1221} + {β}_{2 a} ) ( - {Θ}_{b} + {e}_{tx 2} + {e}_{rx 1} + {e}_{2111} + {β}_{1 a} \qquad ( Equation 5 )$$

$${θ}_{V 11 fb} - {θ}_{V 15 fb} = ( {Θ}_{c} + {e}_{tx 1} + {e}_{rx 1} + {e}_{1213} + {β}_{1 a} ) - ( {Θ}_{c} + {e}_{tx 2} + {e}_{rx 2} + {e}_{2121} + {β}_{2 a} ) \qquad ( Equation 6 )$$

In the above equations, Θₐ, Θ_{b}, and Θ_{c} are phase errors caused by the target. eₜₓ₁ is the phase error of the signal generated in the first transmission circuit 3_1. eₜₓ₂ is the phase error of the signal generated in the second transmission circuit 3_2. eᵣₓ₁ is the phase error of the signal generated in the first reception circuit 4_1, and eᵣₓ₂ is the phase error of the signal generated in the second reception circuit 4_2. e_{abij} is the phase error caused by the wiring length difference L_{abij}.

Further, β is the clock phase error. The subscript attached to the lower right of β is used to distinguish the reception circuit 4 in which each clock phase error occurs and the target of the peak. Specifically, the clock phase error occurring in the phase difference of the detection peak for target k in the nth reception circuit is denoted as βₙₖ.

Here, the clock phase error can be expressed by Equation (7) below, where δTn is the delay time of the clock signal in the nth reception circuit 4 relative to the reference time, and fk is the beat frequency of target k.

$${β}_{n k} = δ {T}_{n} \cdot {f}_{k} \qquad ( Equation 6 )$$

In phase compensation, it is sufficient to consider the relative phase error between transmission circuits 3 and the relative phase error between reception circuits 4. Furthermore, in phase compensation, it is sufficient to consider the relative clock phase error caused by the delay time of the clock signal to other reception circuits 4, using the arrival time of the clock signal at any one reception circuit 4 as the reference time. Therefore, in the following, the relative phase error of the second transmission circuit 3_2 with respect to the first transmission circuit 3_1, and the relative phase error of the second reception circuit 4_2 with respect to the first reception circuit 4_1, will be considered. Furthermore, as shown in FIG. 12, the clock phase error is considered with the arrival time of the clock signal at the first reception circuit 4_1 as the reference time. In this case, eₜₓ₁, eᵣₓ₁, and β₁ₖ can be set to zero.

Based on the above, Equations (1) to (6) can be transformed into the following Equations (8) to (13):

$${θ}_{V 3 fa} - {θ}_{V 7 fa} = {e}_{rx 2} + ( {L}_{1121} - {L}_{1211} ) \cdot K + δ {T}_{2} \cdot {f}_{a} \qquad ( Equation 8 )$$

$${θ}_{V 9 fa} - {θ}_{V 13 fa} = - {e}_{tx 2} + {e}_{rx 2} + ( {L}_{1221} - {L}_{2111} ) \cdot K + δ {T}_{2} \cdot {f}_{a} \qquad ( Equation 9 )$$

$${θ}_{V 11 fa} - {θ}_{V 15 fa} = - {e}_{tx 2} - {e}_{rx 2} + ( {L}_{1213} - {L}_{2121} ) \cdot K - δ {T}_{2} \cdot {f}_{a} \qquad ( Equation 10 )$$

$${θ}_{V 3 fb} - {θ}_{V 7 fb} = {e}_{rx 2} + ( {L}_{1121} - {L}_{1211} ) \cdot K + δ {T}_{2} \cdot {f}_{b} \qquad ( Equation 11 )$$

$${θ}_{V 9 fb} - {θ}_{V 13 fb} = - {e}_{tx 2} + {e}_{rx 2} + ( {L}_{1221} - {L}_{2111} ) \cdot K + δ {T}_{2} \cdot {f}_{b} \qquad ( Equation 12 )$$

$${θ}_{V 11 fb} - {θ}_{V 15 fb} = - {e}_{tx 2} - {e}_{rx 2} + ( {L}_{1213} - {L}_{2121} ) \cdot K - δ {T}_{2} \cdot {f}_{b} \qquad ( Equation 13 )$$

Here, Equations (8) to (13) are converted into matrix form. In this case, the phase differences of each set and the relative phase errors satisfy the relationship expressed by Equation (14) below.

$$( \begin{matrix}{θ}_{V 3 fa} - {θ}_{V 7 fa} \\ {θ}_{V 9 fa} - {θ}_{V 13 fa} \\ {θ}_{V 11 fa} - {θ}_{V 15 fa} \\ {θ}_{V 3 fb} - {θ}_{V 7 fb} \\ {θ}_{V 9 fb} - {θ}_{V 13 fb} \\ {θ}_{V 11 fa} - {θ}_{V 15 fa}\end{matrix} ) = ( \begin{matrix}0 & 1 & {L}_{1121} - {L}_{1211} & {f}_{a} \\ - 1 & 1 & {L}_{1221} - {L}_{2111} & {f}_{a} \\ - 1 & - 1 & {L}_{1213} - {L}_{2121} & - {f}_{a} \\ 0 & 1 & {L}_{1121} - {L}_{1211} & {f}_{b} \\ - 1 & 1 & {L}_{1221} - {L}_{2111} & {f}_{b} \\ - 1 & - 1 & {L}_{1213} - {L}_{2121} & - {f}_{b}\end{matrix} ) \cdot ( \begin{matrix}{e}_{tx 2} \\ {e}_{rx 2} \\ K \\ δ {T}_{2}\end{matrix} ) \qquad ( Equation 14 )$$

Here, the term on the left side of Equation (14) is the phase difference vector Y1 between overlapping virtual antennas V. The first term on the right side of Equation (14) is the coefficient matrix A1. The second term is the phase error vector X1. In Equation (14), the phase difference vector Y1 can be calculated from the phase of the peaks in each beat signal. The coefficient matrix A1 is a constant matrix defined by the combination of transmission circuits 3 and reception circuits 4 for each set of virtual antennas V. Therefore, Equation (14) can be solved as a system of simultaneous equations with eₜₓ₂, eᵣₓ₂, K, and δT₂ as unknowns. That is, the compensation unit 64 acquires eₜₓ₂, eᵣₓ₂, and K as the relative phase error of the second transmission circuit 3_2 with respect to the first transmission circuit 3_1, the relative phase error of the second reception circuit 4_2 with respect to the first reception circuit 4_1, and the relative phase error corresponding to the wiring length difference, respectively, as the solution to Equation (14). The compensation unit 64 also acquires δT₂ as the clock phase error of the second reception circuit 4_2 with respect to the first reception circuit 4_1, as the solution to Equation (14).

In amplitude compensation processing, the compensation unit 64, similarly to phase compensation processing, defines a linear equation for each of at least Ns+Nr−1 belonging sets of virtual antennas V, based on the amplitude difference of the peaks in the beat signals, with the amplitude errors between transmission circuits 3 and between reception circuits 4 as unknowns. The compensation unit 64 obtains the solution to this linear equation as the relative amplitude error. The amplitude difference of the peaks in the beat signals is an example of the comparison result of the reception signals between virtual antennas V.

The amplitude error due to the wiring length difference with respect to the reference wiring length Lo increases linearly according to the wiring length difference, similarly to the phase error. The increase in amplitude error corresponding to the wiring length difference varies according to temperature. That is, the amplitude error caused by the wiring length difference is a value obtained by multiplying the wiring length difference by parameter a.

In the following description, the same sets of virtual antennas V used in the above phase compensation processing are also utilized in amplitude compensation processing. In the following explanation, the amplitude at the peak of the beat signal corresponding to virtual antenna Vn is denoted as A_{Vn} (where n is a natural number). Let G_{abij} denote the amplitude error caused by the wiring length difference L_{abij}; then, the amplitude difference of the peak for (V3, V7), A_{V3}-A_{V7}, is defined by Equation (15); the amplitude difference of the peak for (V9, V13), A_{V9}-A_{V13}, is defined by Equation (16); and the amplitude difference of the peak for (V11, V15), A_{V11}-A_{V15}, is defined by Equation (17).

$${A}_{V 3} - {A}_{V 7} = ( {G}_{a} + {G}_{tx 1} + {G}_{rx 2} + {G}_{1121} ) - ( {G}_{a} + {G}_{tx 1} + {G}_{r x 1} + {G}_{1211} ) \qquad ( Equation 15 )$$

$${A}_{V 9} - {A}_{V 13} = ( {G}_{b} + {G}_{tx 1} + {G}_{r x 2} + {G}_{1221} ) - ( {G}_{b} + {G}_{tx 2} + {G}_{r x 1} + {G}_{2111} ) \qquad ( Equation 16 )$$

$${A}_{V 11} - {A}_{V 15} = ( {G}_{c} + {G}_{tx 1} + {G}_{r x 1} + {G}_{1213} ) - ( {G}_{c} + {G}_{tx 2} + {G}_{r x 2} + {G}_{2121} ) \qquad ( Equation 17 )$$

In the above equations, Gₐ, G_{b}, and G_{c} are amplitude errors caused by the target, respectively. Gₜₓ₁ is the amplitude error of the signal generated in the first transmission circuit 3_1. Gₜₓ₂ is the amplitude error of the signal generated in the second transmission circuit 3_2. Gᵣₓ₁ is the amplitude error of the signal generated in the first reception circuit 4_1, and Gᵣₓ₂ is the amplitude error of the signal generated in the second reception circuit 4_2.

Here, as in phase compensation, the relative amplitude error of the second transmission circuit 3_2 with respect to the first transmission circuit 3_1, and the relative amplitude error of the second reception circuit 4_2 with respect to the first reception circuit 4_1, are considered. In this case, Gₜₓ₁ and Gᵣₓ₁ can be set to zero. Therefore, Equations (15) to (17) can be transformed into the following Equations (18) to (20):

$${A}_{V 3} - {A}_{V 7} = {G}_{r x 2} + ( {L}_{1121} - {L}_{1211} ) \cdot α \qquad ( Equation 18 )$$

$${A}_{V 9} - {A}_{V 13} = - {G}_{tx 2} + {G}_{r x 2} + ( {L}_{1221} - {L}_{2111} ) \cdot α \qquad ( Equation 19 )$$

$${A}_{V 11} - {A}_{V 15} = - {G}_{tx 2} - {G}_{r x 2} + ( {L}_{1213} - {L}_{2121} ) \cdot α \qquad ( Equation 20 )$$

Here, Equations (18) to (20) are converted into matrix form. In this case, the amplitude differences of each set and the relative amplitude errors satisfy the relationship expressed by Equation (21) below.

$$( \begin{matrix}{A}_{V 3} - {A}_{V 7} \\ {A}_{V 9} - {A}_{V 13} \\ {A}_{V 11} - {A}_{V 15}\end{matrix} ) = ( \begin{matrix}0 & 1 & {L}_{1121} - {L}_{1211} \\ - 1 & 1 & {L}_{1222} - {L}_{2112} \\ - 1 & - 1 & {L}_{1213} - {L}_{2121}\end{matrix} ) \cdot ( \begin{matrix}{G}_{tx 2} \\ {G}_{r x 2} \\ α\end{matrix} ) \qquad ( Equation 21 )$$

Here, the term on the left side of Equation (21) is the amplitude difference vector Y2 between overlapping virtual antennas V. The first term on the right side of Equation (21) is the coefficient matrix A2. The second term is the amplitude error vector X2. The amplitude difference vector Y2 can be calculated from the amplitude of the peaks in each beat signal. The coefficient matrix A2 is a constant matrix defined by the combination of transmission circuits 3 and reception circuits 4 for each set of virtual antennas V. That is, the compensation unit 64 acquires Gₜₓ₂, Gᵣₓ₂, and a as the relative amplitude error of the second transmission circuit 3_2 with respect to the first transmission circuit 3_1, the relative amplitude error of the second reception circuit 4_2 with respect to the first reception circuit 4_1, and the relative amplitude error due to wiring length, respectively, as the solution to Equation (21).

Then, in S100, the compensation unit 64 compensates for the phase error between transmission circuits 3 and between reception circuits 4. For example, the compensation unit 64 stores the acquired relative phase error in the memory 6a as compensation data for use in subsequent relative angle acquisition. Furthermore, in S110, the compensation unit 64 compensates for the relative amplitude error between transmission circuits 3 and between reception circuits 4 by storing the compensation data in the memory 6a.

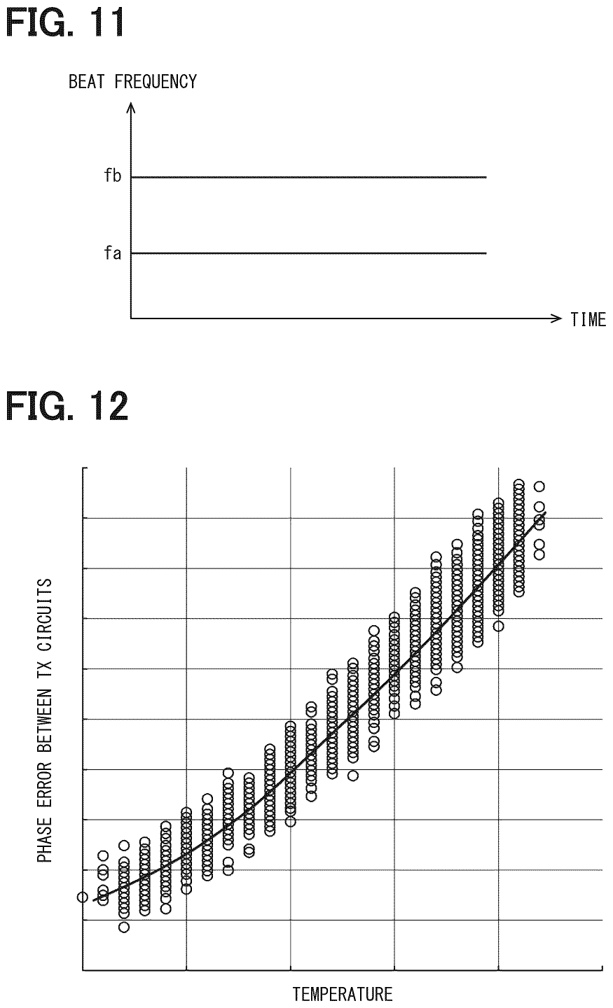

On the other hand, if it is determined in S70 that there are not multiple valid peaks, that is, only one valid peak exists or is determined to exist, the flow proceeds to S120. In S120, the compensation unit 64 acquires the temperature of each transmission circuit 3 and each reception circuit 4 from the temperature sensor 5. Then, in S130, the compensation unit 64 reads out compensation data for the phase error and amplitude error between transmission circuits 3 according to the temperature from the memory 6a. The compensation unit 64 reads out, as compensation data, data relating to the relationship between temperature and the phase error between circuits 3 and 4, as shown in the graphs of FIG. 10 and FIG. 11. The compensation data may be in the form of a relational expression or a table format.

Next, in S140, the compensation unit 64 acquires the relative phase error between transmission circuits 3 and between reception circuits 4 by comparing the acquired temperature with the compensation data. In S150, the compensation unit 64 acquires the relative amplitude error between transmission circuits 3 and between reception circuits 4 by comparing the acquired temperature with the compensation data. In S160, the compensation unit 64 compensates for the relative phase error between transmission circuits 3 and between reception circuits 4. Furthermore, in S170, the compensation unit 64 compensates for the relative amplitude error between transmission circuits 3 and between reception circuits 4.

After S110 or S170, in S180, the angle acquisition unit 65 acquires the relative angle of the target. Specifically, the angle acquisition unit 65 executes FFT processing on multiple peaks extracted from the beat signals based on the reception signals of each virtual antenna V after compensation, thereby acquiring the phase difference between virtual antennas V. Since the phase difference between virtual antennas V is related to the relative angle of the target, the angle acquisition unit 65 acquires the relative angle by converting the acquired phase difference into a relative angle.

According to this first embodiment, based on the comparison result of the reception signals between virtual antennas in at least Ns+Nr−1 belonging sets, it is possible to compensate for the phase difference between different transmission circuits, the phase difference between different reception circuits, the phase difference corresponding to the wiring length difference between virtual antennas, and the phase difference due to the delay of the clock signal. Therefore, the compensation accuracy in the radar apparatus 1 can be improved.

### Second Embodiment

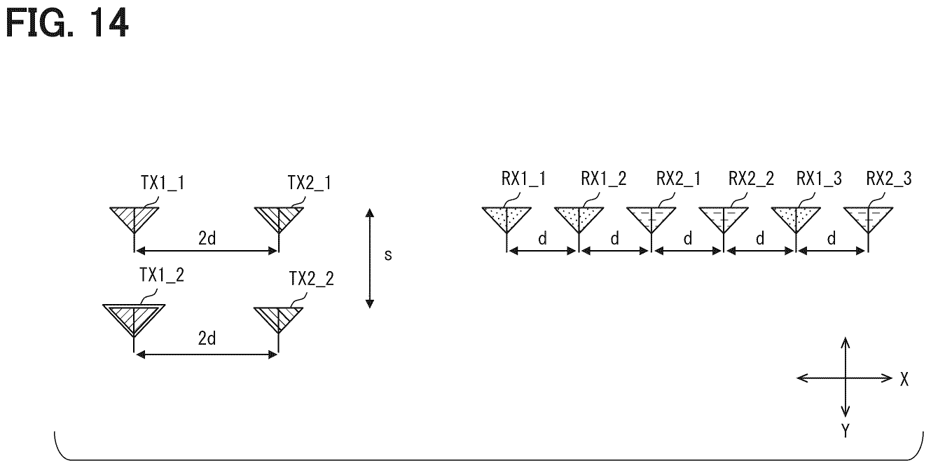

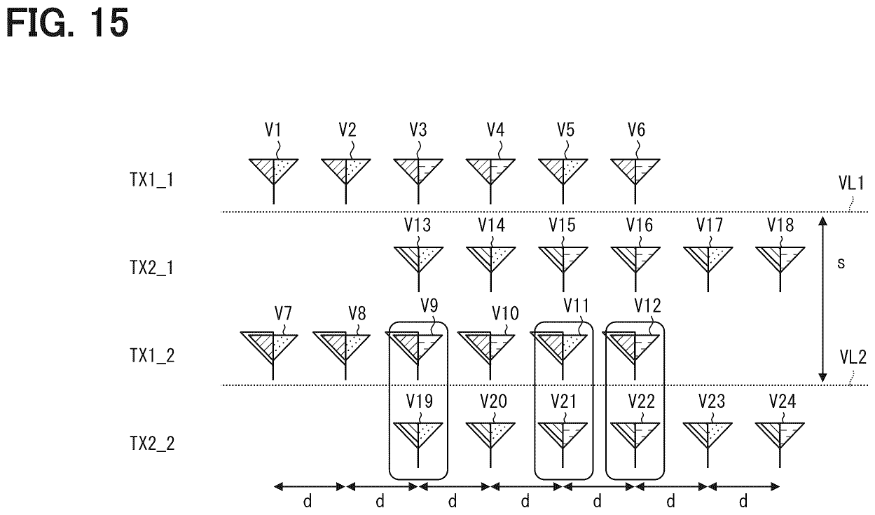

As shown in FIG. 14 and FIG. 15, the second embodiment is a variation of the first embodiment. In the second embodiment, the transmission antennas TX are arranged in a two-dimensional manner. That is, the transmission antennas TX are arranged at equal intervals in two reference directions, respectively.

In the second embodiment, the numbers of transmission antennas TX and reception antennas RX are the same as in the first embodiment. Likewise, the numbers of transmission circuits 3 and reception circuits 4 are also the same as in the first embodiment.

In the example shown in FIG. 14, the transmission antennas TX1_1 and TX2_1 are arranged at intervals of 2d along the X direction from one side to the other in this order. Furthermore, the transmission antennas TX1_2 and TX1_2 are arranged at intervals of s along the Y direction, which is orthogonal to the X direction, from one side to the other in this order. The transmission antennas TX2_1 and TX2_2 are also arranged at intervals of s along the Y direction from one side to the other in this order. That is, the transmission antennas TX1_2 and TX2_2 are arranged parallel to TX1_1 and TX2_1 with an interval of 2d.

The reception antennas RX1_1, RX1_2, RX2_1, RX2_2, RX2_3, and RX1_3 are arranged at intervals of d along the X direction from one side to the other in this order. Since the numbers of antennas TX and RX are the same as in the first embodiment, a total of 24 virtual antennas V are assumed in the second embodiment as well, as shown in FIG. 15.

Since adjacent transmission antennas TX in the X direction are arranged at intervals of 2d, the array of virtual antennas V assumed for a particular transmission antenna TX is relatively shifted by 2d in virtual position compared to the array of virtual antennas V assumed for an adjacent transmission antenna TX in the X direction. Furthermore, since adjacent transmission antennas TX in the Y direction are arranged at intervals of s, the array of virtual antennas V assumed for a particular transmission antenna TX is relatively shifted by s in virtual position compared to the array of virtual antennas V assumed for an adjacent transmission antenna TX in the Y direction.

In FIG. 15, as in FIG. 4, the virtual positions of multiple virtual antennas V for each transmission antenna TX are depicted offset in the vertical direction of the page for clarity. In reality, the multiple virtual antennas V assumed for transmission antennas TX1_1 and TX2_1 are assumed to be located on a virtual line VL1 extending in the X direction. The multiple virtual antennas V assumed for transmission antennas TX1_2 and TX2_2 are assumed to be located on a virtual line VL2 extending in the X direction. The arrays of virtual antennas V on virtual line VL1 and virtual line VL2 are separated by a distance s in the Y direction.

Therefore, as shown in FIG. 15, among the multiple virtual antennas V assumed for transmission antenna TX1_1 and those assumed for transmission antenna TX2_1, sets of virtual antennas V with overlapping virtual positions can be assumed. Specifically, (V3, V13), (V4, V14), (V5, V15), and (V6, V16) constitute sets of virtual antennas V with overlapping virtual positions.

Similarly, among the multiple virtual antennas V assumed for transmission antenna TX1_2 and those assumed for transmission antenna TX2_2, sets of virtual antennas V with overlapping virtual positions can be assumed. Specifically, (V9, V19), (V10, V20), (V11, V21), and (V12, V22) constitute sets of virtual antennas V with overlapping virtual positions.

All of the above sets constitute a collection of sets in which the combination of transmission circuit 3 and reception circuit 4 does not overlap between virtual antennas V. Among this collection, the number of sets in which the combination of transmission circuit 3 and reception circuit 4 does not overlap with other sets is three, satisfying the condition of at least Ns+Nr−2 sets.

Examples of such three sets include (V3, V13), (V5, V15), and (V6, V16). Another example of three sets includes (V9, V19), (V11, V21), and (V12, V22).

Note that (V4, V14), (V9, V19), and (V10, V20) overlap in the combination of transmission circuit 3 and reception circuit 4 with (V3, V13), but do not overlap with other sets. Therefore, assuming (V4, V14), (V9, V19), or (V10, V20) as one of the three sets is equivalent to assuming (V3, V13). Similarly, assuming (V11, V21) as one of the three sets is equivalent to assuming (V5, V15), and assuming (V12, V22) is equivalent to assuming (V6, V16).

Furthermore, among the above unique sets, the three sets (V9, V19), (V11, V21), and (V12, V22) are also different wiring length sets. Therefore, the condition of at least one different wiring length set is also satisfied.

Accordingly, there are at least three belonging sets that belong to at least one of the unique sets and different wiring length sets, satisfying the condition of at least Ns+Nr−1 sets. Examples of three belonging sets include (V9, V19), (V11, V21), and (V12, V22). Note that one or two of (V9, V19), (V11, V21), and (V12, V22) may be replaced with sets having the equivalent relationship described above as belonging sets.

### Third Embodiment

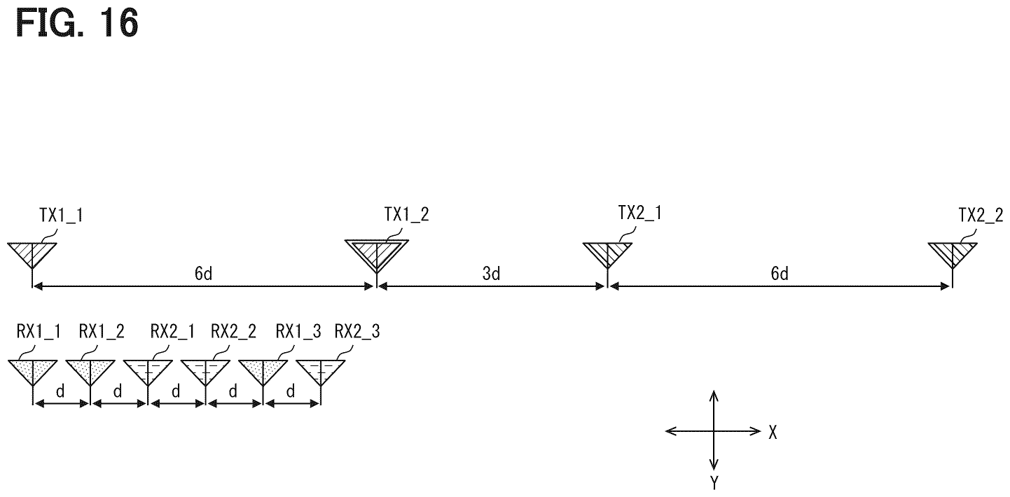

As shown in FIG. 16 to FIG. 18, the third embodiment is a variation of the first embodiment. In the radar apparatus 1 of the third embodiment, the numbers of transmission antennas TX and reception antennas RX, as well as the numbers of transmission circuits 3 and reception circuits 4, are the same as in the first embodiment. Furthermore, the combinations of transmission antennas TX and transmission circuits 3, and the combinations of reception antennas RX and reception circuits 4, are the same as those shown in FIG. 2.

In this embodiment, the transmission antennas TX are arranged at unequal intervals. In the example shown in FIG. 16, the transmission antennas TX1_1, TX1_2, TX2_1, and TX2_2 are arranged along the X direction, which serves as the reference direction, from one side to the other in this order. transmission antennas TX1_1 and TX1_2 are arranged with an interval of 6d. transmission antennas TX1_2 and TX2_1 are arranged with an interval of 3d. transmission antennas TX2_1 and TX2_2 are arranged with an interval of 6d.

Furthermore, the reception antennas RX1_1, RX1_2, RX2_1, RX2_2, RX2_3, and RX1_3 are arranged at intervals of d along the reference direction from one side to the other in this order.

For each transmission antenna TX1_1, TX1_2, TX2_1, and TX2_2, six virtual antennas V are assumed, corresponding to the number of reception antennas RX. Therefore, a total of 24 virtual antennas V are assumed.

The multiple virtual antennas V assumed for transmission antenna TX1_1, from one side to the other, are referred to as virtual antennas V1, V2, V3, V4, V5, and V6. The multiple virtual antennas V assumed for transmission antenna TX1_2, from one side to the other, are referred to as virtual antennas V7, V8, V9, V10, V11, and V12. The group of virtual antennas V assumed for transmission antenna TX2_1, from one side to the other, are referred to as virtual antennas V13, V14, V15, V16, V17, and V18. The group of virtual antennas V assumed for transmission antenna TX2_2, from one side to the other, are referred to as virtual antennas V19, V20, V21, V22, V23, and V24.

Since transmission antennas TX1_1 and TX1_2 are arranged at an interval of 6d, the group of virtual antennas V assumed for transmission antenna TX1_1 is relatively shifted by 6d in virtual position compared to the group of virtual antennas V assumed for transmission antenna TX1_2. Since transmission antennas TX1_2 and TX2_1 are arranged at an interval of 3d, the group of virtual antennas V assumed for transmission antenna TX1_2 is relatively shifted by 3d in virtual position compared to the group of virtual antennas V assumed for transmission antenna TX2_1. Furthermore, since transmission antennas TX2_1 and TX2_2 are arranged at an interval of 6d, the group of virtual antennas V assumed for transmission antenna TX2_1 is relatively shifted by 6d in virtual position compared to the group of virtual antennas V assumed for transmission antenna TX2_2.

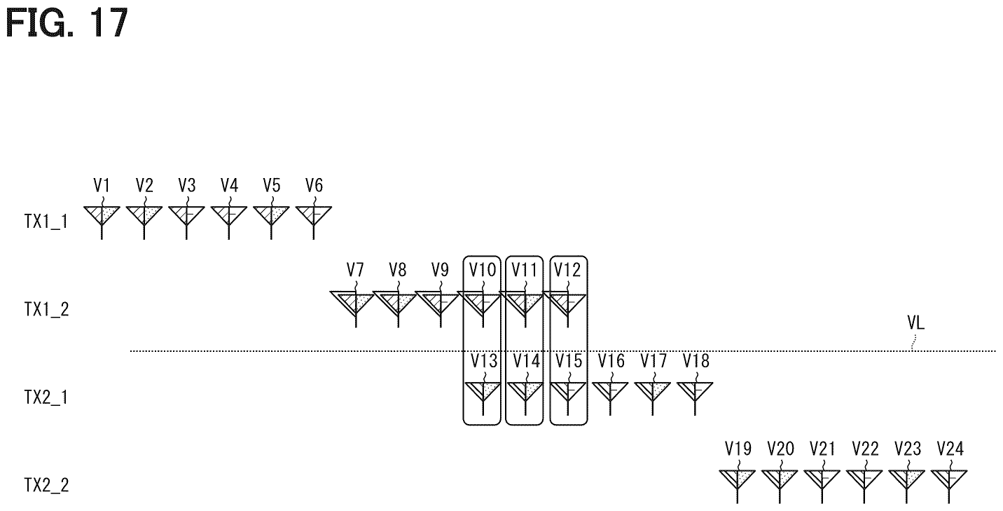

Therefore, with such arrangement of antennas TX and RX, as shown in FIG. 17, there are three sets of virtual antennas V with overlapping virtual positions. In FIG. 17, as in previous figures, the virtual positions of multiple virtual antennas V for each transmission antenna TX are depicted offset in the vertical direction of the page for clarity. In reality, the multiple virtual antennas V are assumed to be located on a virtual line VL extending in the reference direction (X direction), with each virtual position defined accordingly. Specifically, (V10, V13), (V11, V14), and (V12, V15) constitute sets of virtual antennas V with overlapping virtual positions.

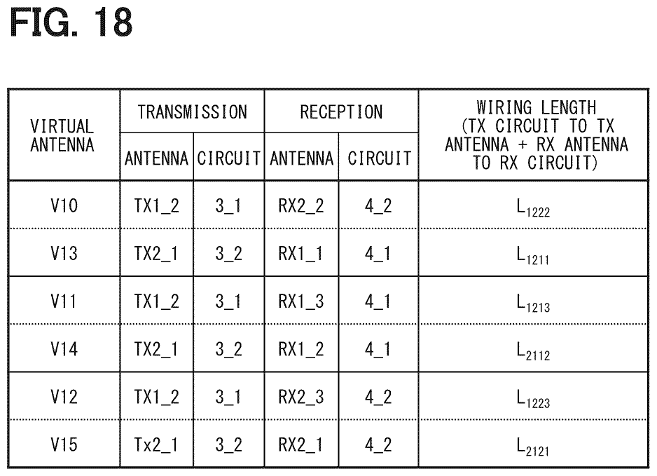

As shown in FIG. 17 and FIG. 18, these three sets constitute a collection of sets in which the combination of transmission circuit 3 and reception circuit 4 does not match between virtual antennas V. Furthermore, these three sets are sets in which the combination of transmission circuit 3 and reception circuit 4 does not overlap with other sets. Therefore, the number of unique sets in this antenna arrangement is three, satisfying the condition of at least Ns+Nr−2 sets.

Furthermore, these three sets are each different wiring length sets. That is, the wiring lengths of virtual antennas V10, V11, and V12 are longer than those of virtual antennas V13, V14, and V15. Therefore, the number of different wiring length sets in this antenna arrangement is three, satisfying the condition of at least one set. Accordingly, in this antenna arrangement, the number of belonging sets is three, satisfying the condition of at least Ns+Nr−1 sets.

### Fourth Embodiment

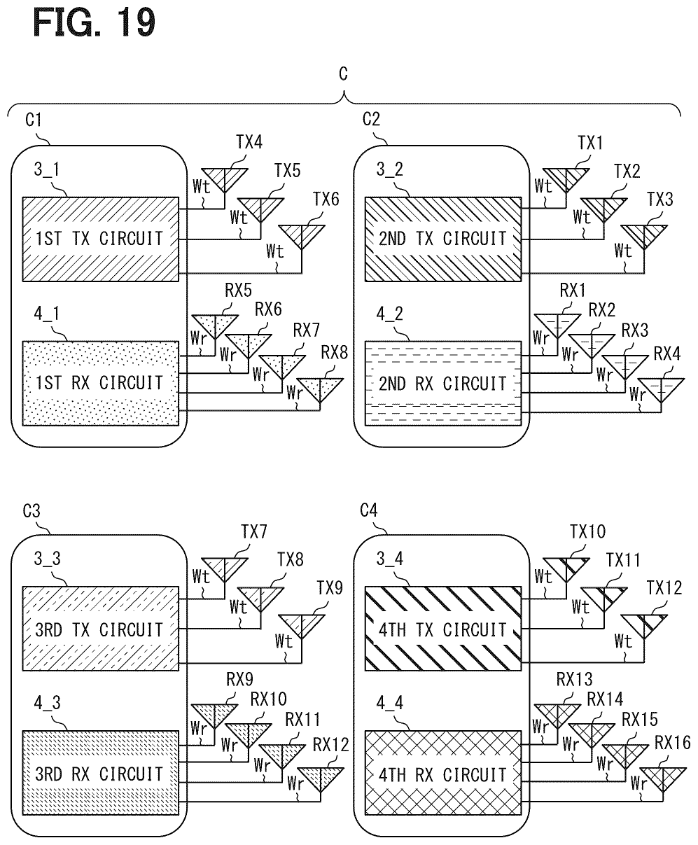

As shown in FIG. 19 to FIG. 22, the fourth embodiment is a variation of the first embodiment. In the fourth embodiment, the transmission antennas TX and reception antennas RX are arranged two-dimensionally, and the transmission antennas TX are arranged at unequal intervals.

In this embodiment, a radar apparatus 1 equipped with twelve transmission antennas TX and sixteen reception antennas RX is assumed. Furthermore, in this embodiment, the number of transmission circuits 3 is Ns=4, and the number of reception circuits 4 is Nr=4. In this case, as shown in FIG. 19, the number of channels in one transmission circuit 3 is at least three, and the number of channels in one reception circuit 4 is at least four. Hereinafter, the four transmission circuits 3 may be distinguished as the first transmission circuit 3_1, the second transmission circuit 3_2, the third transmission circuit 3_3, and the fourth transmission circuit 3_4. Similarly, the four reception circuits 4 may be distinguished as the first reception circuit 4_1, the second reception circuit 4_2, the third reception circuit 4_3, and the fourth reception circuit 4_4.

In this embodiment as well, each circuit is implemented on a plurality of circuit chips C. Specifically, the first transmission circuit 3_1 and the first reception circuit 4_1 are implemented on the same first circuit chip C1, the second transmission circuit 3_2 and the second reception circuit 4_2 are implemented on the same second circuit chip C2, the third transmission circuit 3_3 and the third reception circuit 4_3 are implemented on the same third circuit chip C3, and the fourth transmission circuit 3_4 and the fourth reception circuit 4_4 are implemented on the same fourth circuit chip C4. The wiring length of each wiring Wt between the transmission antenna TX and the corresponding transmission circuit 3, and the wiring length of each wiring Wr between the reception antenna RX and the corresponding reception circuit 4, are specified such that the wiring length of each assumed virtual antenna V has the relative relationship shown in the graph of FIG. 22. That is, at least one of the wiring length from each transmission circuit 3 to each transmission antenna TX and the wiring length from each reception antenna RX to each reception circuit 4 is specified so that the wiring length of the corresponding virtual antenna V has the relative relationship shown in FIG. 22.

Hereinafter, the twelve transmission antennas TX and sixteen reception antennas RX may be distinguished by assigning different reference numerals to each. Specifically, the three transmission antennas TX connected to the first transmission circuit 3_1 are referred to as transmission antennas TX4, TX5, and TX6; the three transmission antennas TX connected to the second transmission circuit 3_2 are referred to as transmission antennas TX1, TX2, and TX3; the three transmission antennas TX connected to the third transmission circuit 3_3 are referred to as transmission antennas TX7, TX8, and TX9; and the three transmission antennas TX connected to the fourth transmission circuit 3_4 are referred to as transmission antennas TX10, TX11, and TX12.

Similarly, the four reception antennas RX connected to the first reception circuit 4_1 are referred to as reception antennas RX5, RX6, RX7, and RX8; the four reception antennas RX connected to the second reception circuit 4_2 are referred to as reception antennas RX1, RX2, RX3, and RX4; the four reception antennas RX connected to the third reception circuit 4_3 are referred to as reception antennas RX9, RX10, RX11, and RX12; and the four reception antennas RX connected to the fourth reception circuit 4_4 are referred to as reception antennas RX13, RX14, RX15, and RX16.

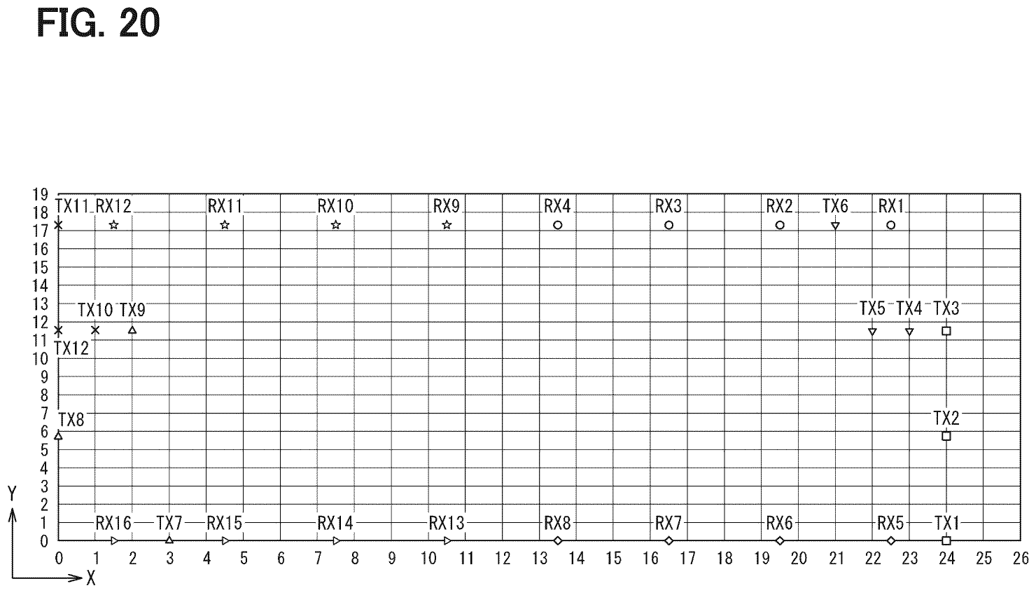

The above transmission antennas TX and reception antennas RX are arranged two-dimensionally. As shown in FIG. 20, four columns of multiple transmission antennas TX aligned in the X direction are arranged at intervals in the Y direction. Among these four columns aligned in the X direction, the first, second, and fourth columns from the origin each have two transmission antennas TX. Furthermore, in the third column from the origin, six transmission antennas TX are arranged. Here, the interval of one scale in the X direction is d, and the interval of one scale in the Y direction is s. transmission antennas TX12, TX10, and TX9 are arranged at equal intervals of d. transmission antennas TX5, TX4, and TX3 are also arranged at equal intervals of d. On the other hand, the interval between transmission antenna TX9 and transmission antenna TX5 is 20d. That is, in this third column, the transmission antennas TX are arranged at unequal intervals in the X direction.

Furthermore, two columns of multiple reception antennas RX aligned in the X direction are arranged at intervals in the Y direction. In each of these columns aligned in the X direction, eight reception antennas RX are arranged. In each column, these reception antennas RX are arranged at equal intervals in the X direction. Furthermore, among the two columns aligned in the X direction, the first column from the origin in the Y direction is arranged to align with the first column from the origin of the transmission antennas TX in the Y direction. The second column from the origin in the X direction is arranged to align with the fourth column from the origin of the transmission antennas TX in the Y direction.

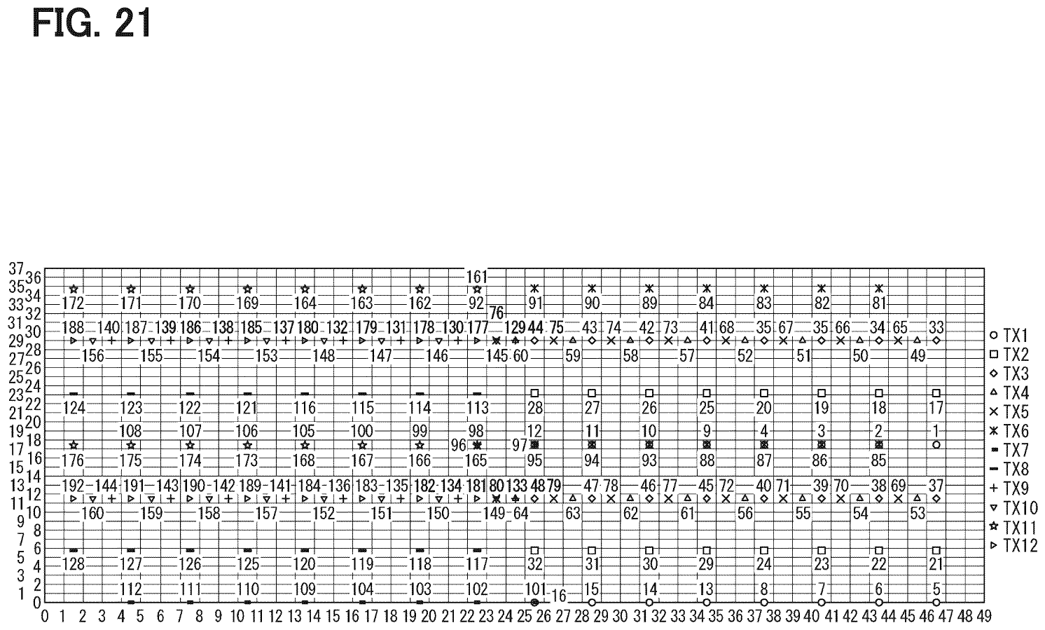

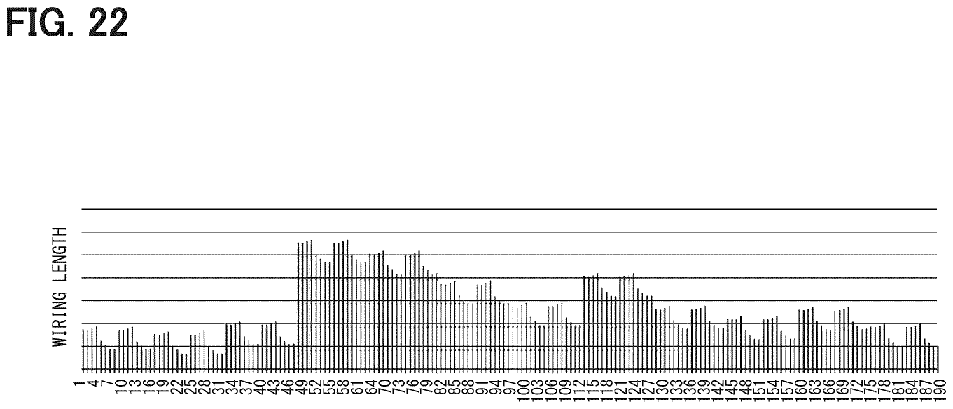

For each of the twelve transmission antennas TX, sixteen virtual antennas V are assumed, corresponding to the number of reception antennas RX. Therefore, in this embodiment, a total of 192 virtual antennas V are assumed. Specifically, the arrangement of the 192 virtual antennas V is as shown in FIG. 21.

Hereinafter, among the sixteen virtual antennas V assumed for a specific transmission antenna TXa, the virtual antenna V corresponding to a specific reception antenna RXb (where a and b are natural numbers) is denoted as Vc (where c=(a−1)×16+b). In FIG. 21, the notation “V” is omitted for clarity.

As shown in FIG. 21, there are 24 sets of virtual antennas V with overlapping virtual positions. Among these, there are 13 unique sets in which the combination of transmission circuit 3 and reception circuit 4 does not overlap with other sets. For example, (V2, V85), (V9, V88), (V10, V93), (V12, V97), (V16, V86), (V60, V129), (V64, V133), (V76, V145), (V80, V149), (V95, V97), (V98, V165), (V105, V168), and (V106, V173) can be assumed as unique sets. The compensation unit 64, described later, performs compensation processing based on the reception signals obtained from at least six sets of these virtual antennas V.

As in the first embodiment, as long as the combination of transmission circuit 3 and reception circuit 4 does not overlap with other sets, sets of virtual antennas V assumed for compensation processing may be other than those described above. For example, (V3, V86) and (V4, V87) overlap in the combination of transmission circuit 3 and reception circuit 4 with (V2, V85), but do not overlap with other sets. Therefore, assuming (V3, V86) or (V4, V87) as one of the 13 sets is equivalent to assuming (V2, V85).

Here, since Ns=4 and Nr=4, in the processing of S80 and S90, the control unit 6 further calculates the phase error and amplitude error between transmission circuits 3, the phase error and amplitude error between reception circuits 4, and the phase error and amplitude error corresponding to the wiring length difference, based on the beat signals from at least seven sets among the belonging sets.

When the numbers of antennas TX and RX are relatively large as described above, the arrangement of antennas TX and RX can be determined by a genetic algorithm. For example, characteristics for evaluating the current generation generated by the genetic algorithm include overlap efficiency, rank, wiring efficiency, FOV (field of view), and separation angle. Overlap efficiency is a parameter obtained by dividing the full rank number by the channel reduction number due to overlapping virtual positions, and it is desirable for this value to be large. Rank is a predetermined parameter. Wiring efficiency is a parameter corresponding to the variance of antenna coordinates input to the same circuit, and it is desirable for this value to be small. FOV is a parameter corresponding to the spacing between antennas, and it is desirable for this value to be small. Separation angle is a parameter corresponding to the aperture length, and it is desirable for this value to be large.

### Fifth Embodiment

The fifth embodiment is a variation of the first embodiment. In the fifth embodiment, the wirings Wt and Wr of all transmission antennas TX and reception antennas RX may be of equal length.

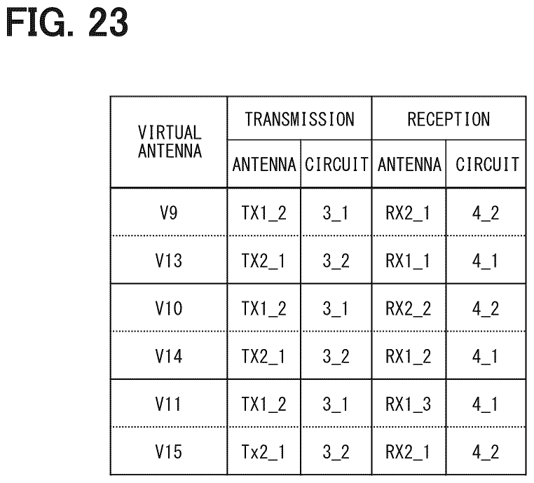

Details regarding the acquisition of relative phase error in the case of equal-length wiring are described below. The phase at the peak of the beat signal corresponding to virtual antenna Vn may be denoted as θ_{Vn} (where n is a natural number). For simplicity, in the following description, only two sets, (V9, V13) and (V11, V15), in which the combination of transmission circuit 3 and reception circuit 4 does not overlap with other sets, as shown in FIG. 23, are used. Additionally, one set, (V10, V14), which overlaps in the combination of transmission circuit 3 and reception circuit 4 with (V9, V13), is used supplementarily.

In this case, the phase difference of the peak for the near target in (V9, V13), θ_{V9fa}-θ_{V13fa}, is defined by Equation (22); the phase difference of the peak for the near target in (V10, V14), θ_{V10fa}-θ_{V14fa}, is defined by Equation (23); and the phase difference of the peak for the near target in (V11, V15), θ_{V11fa}-θ_{V15fa}, is defined by Equation (24). The phase difference of the peak for the far target in (V9, V13), θ_{V9fb}-θ_{V13fb}, is defined by Equation (25); the phase difference of the peak for the far target in (V10, V14), θ_{V10fb}-θ_{V14fb}, is defined by Equation (26); and the phase difference of the peak for the far target in (V11, V15), θ_{V11fb}-θ_{V15fb}, is defined by Equation (27).

$${θ}_{V 9 fa} - {θ}_{V 13 fa} = ( {Θ}_{a} + {e}_{tx 1} + {e}_{r x 2} + {β}_{2 a} ) - ( {Θ}_{a} + {e}_{tx 2} + {e}_{r x 1} + {β}_{1 a} ) \qquad ( Equation 22 )$$

$${θ}_{V 10 fa} - {θ}_{V 14 fa} = ( {Θ}_{b} + {e}_{tx 1} + {e}_{r x 2} + {β}_{2 a} ) - ( {Θ}_{b} + {e}_{tx 2} + {e}_{r x 1} + {β}_{1 a} ) \qquad ( Equation 23 )$$

$${θ}_{V 11 fa} - {θ}_{V 15 fa} = ( {Θ}_{c} + {e}_{tx 1} + {e}_{r x 1} + {β}_{1 a} ) - ( {Θ}_{c} + {e}_{tx 2} + {e}_{r x 2} + {β}_{2 a} ) \qquad ( Equation 24 )$$

$${θ}_{V 9 fb} - {θ}_{V 13 fb} = ( {Θ}_{a} + {e}_{tx 1} + {e}_{r x 2} + {β}_{2 b} ) - ( {Θ}_{a} + {e}_{tx 2} + {e}_{r x 1} + {β}_{1 b} ) \qquad ( Equation 25 )$$

$${θ}_{V 10 fb} - {θ}_{V 14 fb} = ( {Θ}_{b} + {e}_{tx 1} + {e}_{r x 2} + {β}_{2 b} ) - ( {Θ}_{b} + {e}_{tx 2} + {e}_{r x 1} + {β}_{1 b} ) \qquad ( Equation 26 )$$

$${θ}_{V 11 fb} - {θ}_{V 15 fb} = ( {Θ}_{c} + {e}_{tx 1} + {e}_{r x 1} + {β}_{1 b} ) - ( {Θ}_{c} + {e}_{tx 2} + {e}_{r x 2} + {β}_{2 b} ) \qquad ( Equation 27 )$$

Here, Θₐ, Θ_{b}, and Θ_{c} are phase errors caused by the target, respectively. eₜₓ₁ is the phase error of the signal generated in the first transmission circuit 3_1, and eₜₓ₂ is the phase error of the signal generated in the second transmission circuit 3_2. eᵣₓ₁ is the phase error of the signal generated in the first reception circuit 4_1, and eᵣₓ₂ is the phase error of the signal generated in the second reception circuit 4_2.

Here, as in the first embodiment, eₜₓ₁, eᵣₓ₁, and β₁ₖ can be set to zero. Therefore, Equations (22) to (27) can be transformed into the following Equations (28) to (33):

$${θ}_{V 9 fa} - {θ}_{V 13 fa} = - {e}_{tx 2} + {e}_{r x 2} + δ {T}_{2} \cdot {f}_{a} \qquad ( Equation 28 )$$

$${θ}_{V 10 fa} - {θ}_{V 14 fa} = - {e}_{tx 2} + {e}_{r x 2} + δ {T}_{2} \cdot {f}_{a} \qquad ( Equation 29 )$$

$${θ}_{V 11 fa} - {θ}_{V 15 fa} = - {e}_{tx 2} - {e}_{r x 2} - δ {T}_{2} \cdot {f}_{a} \qquad ( Equation 30 )$$

$${θ}_{V 9 fb} - {θ}_{V 13 fb} = - {e}_{tx 2} + {e}_{r x 2} + δ {T}_{2} \cdot {f}_{b} \qquad ( Equation 31 )$$

$${θ}_{V 10 fb} - {θ}_{V 14 fb} = - {e}_{tx 2} + {e}_{r x 2} + δ {T}_{2} \cdot {f}_{b} \qquad ( Equation 32 )$$

$${θ}_{V 11 fb} - {θ}_{V 15 fb} = - {e}_{tx 2} - {e}_{r x 2} - δ {T}_{2} \cdot {f}_{b} \qquad ( Equation 33 )$$

Here, when Equations (28) to (33) are converted into matrix form, the phase differences of each set and the relative phase errors satisfy the relationship expressed by Equation (34):

$$( \begin{matrix}{θ}_{V 9 fa} - {θ}_{V 13 fa} \\ {θ}_{V 10 fa} - {θ}_{V 14 fa} \\ {θ}_{V 11 fa} - {θ}_{V 15 fa} \\ {θ}_{V 9 fb} - {θ}_{V 13 fb} \\ {θ}_{V 10 fb} - {θ}_{V 14 fb} \\ {θ}_{V 11 fb} - {θ}_{V 15 fb}\end{matrix} ) = ( \begin{matrix}- 1 & 1 & {f}_{a} \\ - 1 & 1 & {f}_{a} \\ - 1 & - 1 & - {f}_{a} \\ - 1 & 1 & {f}_{b} \\ - 1 & 1 & {f}_{b} \\ - 1 & - 1 & - {f}_{b}\end{matrix} ) \cdot ( \begin{matrix}{e}_{tx 2} \\ {e}_{r x 2} \\ δ {T}_{2}\end{matrix} ) \qquad ( Equation 34 )$$

The term on the left side of Equation (34) is the phase difference vector Y1 between overlapping virtual antennas V. The first term on the right side of Equation (34) is the coefficient matrix A1, and the second term is the phase error vector X1. The phase difference vector Y1 in Equation (34) is calculated from the phase of the peaks in each beat signal. The coefficient matrix A1 is a constant matrix defined by the combination of transmission circuits 3 and reception circuits 4 for each set of virtual antennas V. Therefore, Equation (34) can be solved as a system of simultaneous equations with eₜₓ₂, eᵣₓ₂, and δT₂ as unknowns. That is, the compensation unit 64 acquires eₜₓ₂ and eᵣₓ₂ as the relative phase error of the second transmission circuit 3_2 with respect to the first transmission circuit 3_1 and the relative phase error of the second reception circuit 4_2 with respect to the first reception circuit 4_1, respectively, as the solution to Equation (34). The compensation unit 64 also acquires δT₂ as the clock phase error of the second reception circuit 4_2 with respect to the first reception circuit 4_1 as the solution to Equation (34).

In amplitude compensation processing, the compensation unit 64, similarly to phase compensation processing, defines a linear equation for each unique set, based on the amplitude difference of the peaks in the beat signals, with the amplitude errors between transmission circuits 3 and between reception circuits 4 as unknowns, and obtains the solution to this linear equation as the relative amplitude error. The amplitude difference of the peaks in the beat signals is an example of the comparison result of the reception signals between virtual antennas V.

In the following description, the same sets of virtual antennas V used in the above phase compensation processing are also utilized in amplitude compensation processing. In this case, the amplitude difference of the peak for (V9, V13), A_{V9}-A_{V13}, is defined by Equation (35); the amplitude difference of the peak for (V10, V14), A_{V10}-A_{V14}, is defined by Equation (36); and the amplitude difference of the peak for (V11, V15), A_{V11}-A_{V15}, is defined by Equation (37).

$${A}_{V 9} - {A}_{V 13} = ( {G}_{a} + {G}_{tx 1} + {G}_{r x 2} ) - ( {G}_{a} + {G}_{tx 2} + {G}_{r x 1} ) \qquad ( Equation 35 )$$

$${A}_{V 14} = ( {G}_{b} + {G}_{tx 1} + {G}_{r x 2} ) - ( {G}_{b} + {G}_{tx 2} + {G}_{r x 1} ) \qquad ( Equation 36 )$$

$${A}_{V 11} - {A}_{V 15} = ( {G}_{c} + {G}_{tx 1} + {G}_{r x 1} ) - ( {G}_{c} + {G}_{tx 2} + {G}_{r x 2} ) \qquad ( Equation 37 )$$

Here, Gₐ, G_{b}, and G_{c} are amplitude errors caused by the target, respectively. Gₜₓ₁ is the amplitude error of the signal generated in the first transmission circuit 3_1, Gₜₓ₂ is the amplitude error of the signal generated in the second transmission circuit 3_2, Gᵣₓ₁ is the amplitude error of the signal generated in the first reception circuit 4_1, and Gᵣₓ₂ is the amplitude error of the signal generated in the second reception circuit 4_2.

Here, as in phase compensation, when considering the relative amplitude error of the second transmission circuit 3_2 with respect to the first transmission circuit 3_1, and the relative amplitude error of the second reception circuit 4_2 with respect to the first reception circuit 4_1, Gₜₓ₁ and Gᵣₓ₁ can be set to zero. Therefore, Equations (35) to (37) can be transformed into the following Equations (38) to (40):

$${A}_{V 9} - {A}_{V 13} = - {G}_{tx 2} + {G}_{r x 2} \qquad ( Equation 38 )$$

$${A}_{V 10} - {A}_{V 14} = - {G}_{tx 2} + {G}_{r x 2} \qquad ( Equation 39 )$$

$${A}_{V 11} - {A}_{V 15} = - {G}_{tx 2} - {G}_{r x 2} \qquad ( Equation 40 )$$

Here, when Equations (38) to (40) are converted into matrix form, the amplitude differences of each set and the relative amplitude errors satisfy the relationship expressed by Equation (41):

$$( \begin{matrix}{A}_{V 9} - {A}_{V 13} \\ {A}_{V 10} - {A}_{V 14} \\ {A}_{V 11} - {A}_{V 15}\end{matrix} ) = ( \begin{matrix}- 1 & 1 \\ - 1 & 1 \\ - 1 & - 1\end{matrix} ) \cdot ( \begin{matrix}{G}_{tx 2} \\ {G}_{r x 2}\end{matrix} ) \qquad ( Equation 41 )$$

The term on the left side of Equation (41) is the amplitude difference vector Y2 between overlapping virtual antennas V. The first term on the right side of Equation (41) is the coefficient matrix A2, and the second term is the amplitude error vector X2. The amplitude difference vector Y2 is calculated from the amplitude of the peaks in each beat signal. The coefficient matrix A2 is a constant matrix. That is, the compensation unit 64 acquires Gₜₓ₂ and Gᵣₓ₂ as the relative amplitude error of the second transmission circuit 3_2 with respect to the first transmission circuit 3_1 and the relative amplitude error of the second reception circuit 4_2 with respect to the first reception circuit 4_1, respectively, as the solution to Equation (41).

According to the fifth embodiment described above, based on the comparison result of the reception signals between virtual antennas in at least Ns+Nr−2 unique sets, it is possible to compensate for the phase difference between different transmission circuits, the phase difference between different reception circuits, and the phase difference due to the delay of the clock signal. Therefore, the compensation accuracy in the radar apparatus 1 can be improved.

### Other Embodiments

The foregoing describes a plurality of embodiments; however, the present disclosure is not to be construed as limited to these embodiments, and may be applied to various embodiments and combinations thereof within the scope not departing from the gist of the present disclosure.

In a modification of the fourth embodiment, both the transmission antennas TX and the reception antennas RX may be arranged at unequal intervals.

In a modification, the dedicated computer constituting the control unit 6 may be a sensor integration ECU that integrally controls multiple types of sensors mounted on a vehicle. The dedicated computer constituting the control unit 6 may be an integrated ECU that integrates driving control of the vehicle. The dedicated computer constituting the control unit 6 may be a judgment ECU that determines driving tasks in vehicle driving control. The dedicated computer constituting the control unit 6 may be a monitoring ECU that monitors vehicle driving control. The dedicated computer constituting the control unit 6 may be an evaluation ECU that evaluates vehicle driving control. The dedicated computer constituting the control unit 6 may be a navigation ECU that navigates the travel route of the vehicle. The dedicated computer constituting the control unit 6 may be a locator ECU that estimates the self-state quantity of the vehicle. The dedicated computer constituting the control unit 6 may be an actuator ECU that controls the travel actuators of the vehicle. The dedicated computer constituting the control unit may be an HCU (HMI (Human Machine Interface) Control Unit) that controls information presentation in the vehicle. The dedicated computer constituting the control unit 6 may be a computer other than the vehicle, such as an external center or mobile terminal capable of communicating with the vehicle.

In a modification, the mobile body to which the radar apparatus 1 is applied may be, for example, an autonomous device (autonomous robot) capable of cargo transport or information collection by autonomous or remote driving. The autonomous device (autonomous robot) includes, for example, an autonomous vehicle. In addition to the embodiments described so far, the above embodiments and modifications may be implemented as a control device mountable on a mobile body, having at least one processor 6b and memory 6a, in the form of a processing circuit (for example, processing ECU, etc.) or a semiconductor device (for example, semiconductor chip, etc.).

What is claimed is:

1. A radar apparatus comprising:
a plurality of transmission antennas;
a plurality of reception antennas;
a number Ns of transmission circuits connected to the transmission antennas and configured to output a transmission signal;
a number Nr of reception circuits connected to the reception antennas and configured to acquire a reception signal;
a clock generation unit configured to output a clock signal to each of the reception circuits; and
a control unit configured to process the reception signals,
wherein
Ns and Nr are each integers of 2 or more,
the plurality of transmission antennas and the plurality of reception antennas are arranged such that:
(i) at least one of the plurality of transmission antennas and the plurality of reception antennas are arranged is arranged at unequal intervals;
(ii) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets;
(iii) at least one different wiring length set is included, which is a set of virtual antennas with overlapping virtual positions and different wiring lengths; and
(iv) a total number of belonging sets, which are sets of virtual antennas belonging to at least one of the unique sets and the different wiring length sets, is at least Ns+Nr−1 sets,
the control unit is configured to, for the detection signals of the same target in the reception signals between the virtual antennas in at least Ns+Nr−1 belonging sets, based on a comparison result for a plurality of targets at different distances, compensate for a phase difference corresponding to the wiring length difference between the virtual antennas, a phase difference between different transmission circuits, a phase difference between different reception circuits, and a phase difference due to delay of the clock signal.

2. The radar apparatus according to claim 1, wherein
the control unit is further configured to compensate for the phase difference due to delay of the clock signal by utilizing the comparison result of the reception signals between the virtual antennas in the set of virtual antennas in which the combination of the transmission circuit and the reception circuit overlaps with other sets.

3. The radar apparatus according to claim 1, wherein
the control unit interrupts compensation of the phase difference due to delay of the clock signal when a plurality of targets at different distances are not detected.

4. A radar apparatus comprising:
a plurality of transmission antennas arranged at equal intervals;
a plurality of reception antennas arranged at equal intervals;
a number Ns of transmission circuits connected to the transmission antennas and configured to output a transmission signal;
a number Nr of reception circuits connected to the reception antennas and configured to acquire a reception signal;
a clock generation unit configured to output a clock signal to each of the reception circuits; and
a control unit configured to process the reception signals,
wherein
Ns and Nr are each integers of 2 or more,
the plurality of transmission antennas and the plurality of reception antennas are arranged such that:
(i) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets;
(ii) at least one different wiring length set is included, which is a set of virtual antennas with overlapping virtual positions and different wiring lengths; and
(iii) a total number of belonging sets, which are sets of virtual antennas belonging to at least one of the unique sets and the different wiring length sets, is at least Ns+Nr−1 sets,
the control unit is configured to, for the detection signals of the same target in the reception signals between the virtual antennas in at least Ns+Nr−1 belonging sets, based on a comparison result for a plurality of targets at different distances, compensate for a phase difference corresponding to the wiring length difference between the virtual antennas, a phase difference between different transmission circuits, a phase difference between different reception circuits, and a phase difference due to delay of the clock signal.

5. The radar apparatus according to claim 4, wherein
the control unit is further configured to compensate for the phase difference due to delay of the clock signal by utilizing the comparison result of the reception signals between the virtual antennas in the set of virtual antennas in which the combination of the transmission circuit and the reception circuit overlaps with other sets.

6. The radar apparatus according to claim 4, wherein
the control unit interrupts compensation of the phase difference due to delay of the clock signal when a plurality of targets at different distances are not detected.

7. A radar apparatus comprising:
a plurality of transmission antennas;
a plurality of reception antennas;
a number Ns of transmission circuits connected to the transmission antennas and configured to output a transmission signal;
a number Nr of reception circuits connected to the reception antennas and configured to acquire a reception signal;
a clock generation unit configured to output a clock signal to each of the reception circuits; and
a control unit configured to process the reception signals,
wherein
Ns and Nr are each integers of 2 or more,
the plurality of transmission antennas and the plurality of reception antennas are arranged such that:
(i) at least one of the plurality of transmission antennas and the plurality of reception antennas are arranged is arranged at unequal intervals; and
(ii) among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets,
the control unit is configured to, for the detection signals of the same target in the reception signals between the virtual antennas in at least Ns+Nr−2 unique sets, based on a comparison result for a plurality of targets at different distances, compensate for a phase difference corresponding to the wiring length difference between the virtual antennas, a phase difference between different transmission circuits, a phase difference between different reception circuits, and a phase difference due to delay of the clock signal.

8. The radar apparatus according to claim 7, wherein
the control unit is further configured to compensate for the phase difference due to delay of the clock signal by utilizing the comparison result of the reception signals between the virtual antennas in the set of virtual antennas in which the combination of the transmission circuit and the reception circuit overlaps with other sets.

9. The radar apparatus according to claim 7, wherein
the control unit interrupts compensation of the phase difference due to delay of the clock signal when a plurality of targets at different distances are not detected.

10. A radar apparatus comprising:
a plurality of transmission antennas arranged at equal intervals;
a plurality of reception antennas arranged at equal intervals;
a number Ns of transmission circuits connected to the transmission antennas and configured to output a transmission signal;
a number Nr of reception circuits connected to the reception antennas and configured to acquire a reception signal;
a clock generation unit configured to output a clock signal to each of the reception circuits; and
a control unit configured to process the reception signals,
wherein
Ns and Nr are each integers of 2 or more,
the plurality of transmission antennas and the plurality of reception antennas are arranged such that:
among a group of virtual antennas assumed for each transmission antenna for the plurality of reception antennas according to a phase difference of the reception signals between the reception antennas, in a collection of sets of virtual antennas in which virtual positions overlap and a combination of the transmission circuit and the reception circuit does not match, there are included at least Ns+Nr−2 unique sets of virtual antennas, each being a set in which a combination of a transmission circuit and a reception circuit does not overlap with other sets,
the control unit is configured to, for the detection signals of the same target in the reception signals between the virtual antennas in at least Ns+Nr−2 unique sets, based on a comparison result for a plurality of targets at different distances, compensate for a phase difference corresponding to the wiring length difference between the virtual antennas, a phase difference between different transmission circuits, a phase difference between different reception circuits, and a phase difference due to delay of the clock signal.

11. The radar apparatus according to claim 10, wherein
the control unit is further configured to compensate for the phase difference due to delay of the clock signal by utilizing the comparison result of the reception signals between the virtual antennas in the set of virtual antennas in which the combination of the transmission circuit and the reception circuit overlaps with other sets.

12. The radar apparatus according to claim 10, wherein
the control unit interrupts compensation of the phase difference due to delay of the clock signal when a plurality of targets at different distances are not detected.
